(19) United States
(12) Patent Application Publication
(10) Pub. No.: US 2013/0138473 A1
(43) Pub. Date: May 30, 2013

(54) Business Process Optimization

(71) Applicants: Soeren Balko, Weinheim (DE); Alexander Dreiling, Kelvin Grove (AU)

(72) Inventors: Soeren Balko, Weinheim (DE); Alexander Dreiling, Kelvin Grove (AU)

(73) Assignee: SAP AG, Walldorf (DE)

(21) Appl. No.: 13/305,538

(22) Filed: Nov. 28, 2011

(51) Int. Cl. G06Q 10/04

(52) U.S. Cl. 705/7.27

(57) ABSTRACT

The present disclosure involves systems, software, and computer implemented methods for optimizing business processes. One process includes identifying a set of information technology (IT) characteristics associated with execution of a process model, identifying at least one optimization goal associated with the process model, identifying a set of at least one optimization technique based on the identified set of IT characteristics and identified optimization goals associated with the process model, and compiling the process model, where compiling the process model includes applying the set of the at least one optimization technique during compiling operations. The set of IT characteristics associated with the execution of the process model can include a landscape type of a target system in which the process model is to be deployed, a probable deployment option of the process model, a probable usage type associated with the process model, and performance factors associated with the target system.

### RELATED APPLICATION

This application is related to U.S. application Ser. No. 13/305,380, titled “Business Process Optimization,” filed Nov. 28, 2011, and fully incorporating the contents therein.

### TECHNICAL FIELD

The present disclosure relates to software, computer systems, and computer-implemented methods for optimizing business processes and business process models.

### BACKGROUND

Business processes typically are required to adhere to basic consistency constraints which require individual process steps to perform their corresponding actions in a fail-safe manner. Technically, business processes employ underlying transactional infrastructure components (e.g., databases, messaging middleware, etc.) to guarantee basic atomicity, consistency, isolation, and durability (ACID) characteristics. While transactions in business processes provide these ACID features, they are generally prohibitively costly in terms of resource consumption (CPU cycles, main memory, input/output, etc.) and potential lock contentions (delays or failures to acquire a lock held by a concurrent transaction). In effect, any process step running in a separate transaction may suffer from, in some cases, a noticeable performance penalty and may be further subjected to adverse effects of the transaction infrastructure's concurrent control mechanisms.

Business process management suites (BPMSs) traditionally break down process models into a large number of independent transactions, where any process step (such as activities, gateways, events, and other suitable steps) may occupy one or many separate transactions. That is, any process step “commits” its effects independently from other process steps. The model is simple to implement and ensures that the ACID criteria hold for executing process steps.

### SUMMARY

The present disclosure involves systems, software, and computer implemented methods for optimizing business processes. One process includes identifying a set of information technology (IT) characteristics associated with execution of a process model, identifying at least one optimization goal associated with the process model, identifying a set of at least one optimization technique based on the identified set of IT characteristics and identified optimization goals associated with the process model, and compiling the process model, where compiling the process model includes applying the set of the at least one optimization technique during compiling operations. The set of IT characteristics associated with the execution of the process model can include a landscape type of a target system in which the process model is to be deployed, a probable deployment option of the process model, a probable usage type associated with the process model, and performance factors associated with the target system.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example environment for implementing various features of a system for providing business process optimization, including extending transactional scopes to include, in some instances, two or more process steps into a single transaction

FIG. 2 is a flowchart of an example method for traversing and transactionally optimizing a business process model at compile-time.

FIGS. 3A-C illustrate examples of optimized process steps combined into transactional sub-processes in a BPMN environment.

FIG. 4 illustrates an example adaptive compiler infrastructure.

FIGS. 5 and 6 illustrate examples associated with premature correlation scope termination.

FIG. 7 illustrates a table providing example optimization goals associated with particular IT landscapes.

FIG. 8 illustrates a table providing an example of suggested sequences of optimizations based on particular optimization goals.

FIG. 9 is a flowchart of an example method for performing an adaptive compilation to a process model.

### DETAILED DESCRIPTION

This disclosure generally relates to software, computer systems, and computer-implemented methods for automatic transaction scope expansion in business processes. Specifically, tools and methods are used to analyze business process models to determine one or more processes and/or operations that can be combined into a single transaction without modifying the functionality of the business process(es), and which allow the business process(es) to execute in a more efficient manner. In some instances, a set of process steps can be combined into a particular sub-process, or transaction. Generally, for business process models running a plurality of independent transactions, a sufficiently large number of concurrently executing processes having even a typical level of complexity, key performance indicators (KPIs) such as process turnaround times and throughput (i.e., the number of processes that can be completed in a given time span) are upper-bounded by the number of transactions that the underlying infrastructure is able to process. Moreover, such transactional infrastructures are often shared among a number of business applications, where a business process management suite (BPMS) executing the business processes is but one of many.

To reduce the load on a transactional infrastructure, some systems may employ a multi-level transaction model where sequential process steps are run in nested transactions that are jointly committed. While the multi-level transaction model may reduce the number of “commits,” such a model can suffer from prohibitively long transaction durations (violating a fairness requirement between transactions), as well as a non-conservative locking profile where a nested transaction can only acquire its locks (among other resources) late during the surrounding transaction's life span. In effect, the nested transaction may fail to acquire a lock or may have to wait some finite, but long or inconvenient, time for the resource to be freed up, further increasing the transaction's latencies.

The tools and functionality of the present disclosure can provide numerous benefits. One benefit may include the significant reduction of the number of transactions required to be run for a business process, while adhering to the full consistency constraints of business processes. In effect, the load on underlying shared transaction infrastructures (e.g., a database) may be reduced. Other applications, including other business processes, business process models, and/or other business applications outside of the BPMS that access the same transactional infrastructure, may equally benefit from the reduced resources.

A second benefit is that the performance, including turnaround times and throughput, may be significantly improved through the optimizations. Memory consumption of business processes may also be improved, enabling more demanding scenarios with regard to system resources to be executed, in turn allowing more process instances to be run simultaneously, without requiring additional resources. Further, hardware resources may be put to better use by maximizing their processing capabilities, thus improving total cost of ownership (TCO) by potentially reducing the number of systems in an information technology (IT) landscape. For example, applications are generally input/output bound, meaning a majority of time the applications are waiting for the underlying database, or transactional infrastructure, to serve their requests. In other words, the business applications cannot fully use their CPU resources. By reducing the number of transactions (and therefore, the input/output load), a business application can use the application server's CPU much more often to make progress. In effect, the application server's hardware is better utilized and overall system performance can be improved.

Further, the likelihood of specific issues occurring during execution of various business applications and their related processes may be lessened through the use of the disclosed tools and systems. For instance, resource contentions (e.g., delayed or failing lock acquisitions) and race conditions (e.g., deadlocks) may be reduced by employing a conservative locking profile that excludes lock conflicts a priori and by reducing the transaction latencies and the number of concurrent transactions. By addressing these issues through technical and compile-time improvements, the TCO is reduced for supporting customers of affected products.

The tools defined in the present application can significantly reduce the number of transactions employed by a BPMS system in order to run a business process, while at the same time maintaining the ACID criteria required by business processes. Further, the tools and system avoid the aforementioned problems of multi-level transactions and provide a “conservative” locking profile (i.e., where all locks can be atomically acquired before the transaction is started), as well as by providing smaller transactional latencies. As a result, the tools and described functionality improve process KPIs, reduce the likelihood of resource contentions, and reduce the static footprint of process binaries created at compile-time that are executed by the BPMS.

The processes and operations described herein address these issues via a compile-time approach where a process model (e.g., a business process modeling notation (BPMN) diagram) is transformed into a process binary (such as a Trigger Network or other executable format understood by a BPMS runtime, such as Business Process Execution Language (BPEL)) or an optimized version of the process model. The optimized process binary or optimized version of the process model can be semantically identical to the original process model in that the same operations and functionality are performed. In other words, the transformed processes can provide the same observable behavior. The difference between the versions is that particular operations may be incorporated into common transactions to allow the advantages of fewer transactions in execution of the business processes to be realized. In some instances, downward compatibility can be fully preserved, as customers and users can benefit from the advances described herein by re-compiling previously created process models. At the same time, newly generated process models can also be compiled prior to execution to realize the same advantages.

The compiler can employ an optimization phase which traverses the process model, following various control flow connectors downstream. Control flow connectors are directed “edges” between process steps (activities, gateways, events, etc.). Following a control flow graph downstream can mean iterating through the process model from one process step to the next in the direction of the control flow connector that links the two neighboring process steps. For any process branch of the process model, the complier can track a current transaction's “boundary,” or the process steps from where the current transaction was started and the downstream process step where the transaction ends, and is committed. Depending on the characteristics of the process step, such as the message exchange pattern (MEP) of the action it performs, the compiler may add the process step to the current transaction or, alternatively, close the current transaction and open a new transaction, marking the current process step as the first operation of a new transaction. As an example, any sequence of process steps that perform outbound service invocations (out-in, out-only, robust out-only) may be chained into a single primary transaction. An asynchronous message receipt (in-only, robust in-only) may mark the start of a primary transaction that chains other sequential process steps. Merging branches (e.g., via gateways) may end the transaction(s) on the inbound branches and open a new transaction for the gateway and its outbound branch. Splitting process steps (e.g., through gateways, boundary events, etc.) can form the last process step of the current transaction where any outbound branch starts a new transaction.

Adding multiple, or chained, process steps to a single transaction can occur by generating, in some instances, a single piece of code, which sequentially performs the actions of the chained process steps in the order of their control flow relation. The code avoids the overhead of running each process step in a nested or self-contained transaction that allocates specific resources for the corresponding transaction (e.g., main memory, connections to the underlying database, operating system threads, etc.). The chaining also allows various technical actions to be eliminated from the chained process steps (e.g., forwarding a token between the chained process steps), can compact some actions within the chained steps (e.g., jointly writing the combined effects of the chained process steps into an audit log, as opposed to each step individually), and can reuse some resources that used to be claimed individually for each process step (e.g., locks on shared data). When a transaction's boundaries are defined using the aforementioned algorithm, the described process and tools can facilitate a conservative locking profile at runtime. Restated, the chain of process steps contained in the transaction can be analyzed for the data the transaction reads and manipulates through its chained process steps. The information returned by this analysis can then be made explicitly available as transaction metadata, available to both the other process steps within the transaction itself, as well as to the corresponding BPMS runtime. The BPMS runtime can identify that metadata to atomically acquire exclusive locks and shared locks on some or all of the data that is manipulated and/or read by some process step chained into a particular transaction. This acquiring of locks can occur before any work is performed by the transaction. When acquiring the locks fails, the transaction may not be started.

In marking particular transactional boundaries, the existing artifacts of the underlying process model, or process metamodel, may be used. For instance, BPMN's transaction sub-processes can be used to force all contained process steps into running as a single transaction. Using existing metamodel artifacts may be attractive and beneficial from a total cost of development (TCD) point of view, as their use avoids the need to create additional intermediate representations to capture transactional boundaries, while also leaving the compiler backend (generating the transactions combining the chained process steps) unaffected, based on an assumption that the compiler backend provides functionality to generate executable code for transactional sub-processes. Transactional boundaries (or transactional sub-processes in BPMN implementations) may introduce additional overhead at runtime for starting and completing the sub-processes themselves, such that some additional optimization stage to expand transactional sub-processes where the prior optimizations are not superior to the additional overhead they may cause are removed. Alternatively, some other metamodel attribute may be used to flag the newly introduced and/or created transactional sub-process (or generally, transactional boundary) such that the code generation phase may later remove the created overhead of the sub-processes.

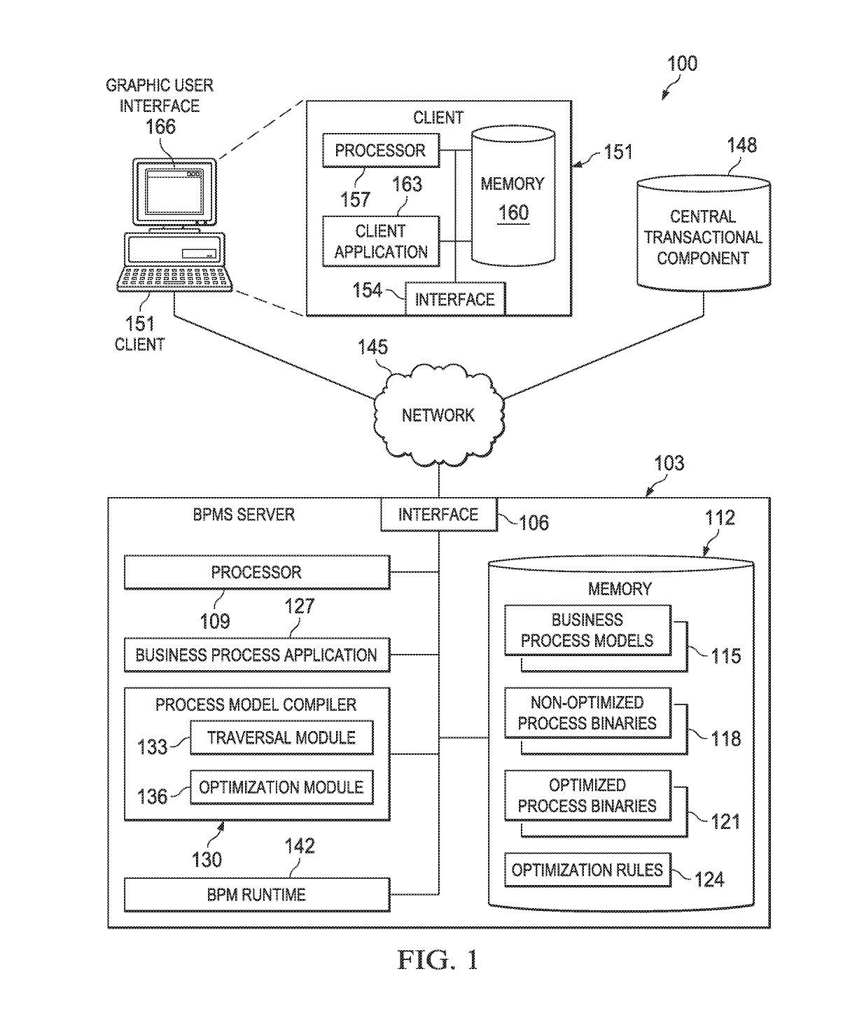

FIG. 1 illustrates an example environment 100 for implementing various features of a system for providing business process optimization, including extending transactional scopes to include, in some instances, two or more process steps into a single transaction. The illustrated environment 100 includes, or is communicably coupled with, a BPMS server 103, a central transactional component 148, and at least one client 151. At least some of the communication between the BPMS server 103, the central transactional component 148, and the client 151 may be performed across or via network 145. In general, environment 100 depicts an example configuration of a system for optimizing business process models into compiled business process binaries that use or execute fewer transactions to perform a process while remaining semantically identical to the original business process model. Restated, a particular business process model can be analyzed and traversed to identify one or more process steps within the process model that are suitable to be combined into one or more transactional boundaries, thereby sharing resources and information prior to performing a final commit when executed. One or more of the advantages described above may be realized by the environment 100, providing more efficient and less error- and issue-prone execution of the particular business process defined by the business process model. The illustrated BPMS server 103 may be a system for optimizing and executing business processes, where the business processes interact with the central transactional component 148, such as a database or messaging middleware system, containing data and other information relevant to the execution of the corresponding business processes. In some instances, different process steps and/or different instances of the business process may request similar portions of data stored at the central transactional component 148, where those requests may be permitted or rejected based on locking mechanisms meant to protect concurrent and incompatible changes made to the same set of data. Various types of locking mechanisms and rules may be applied at the central transactional component in an attempt to protect information from corruption or errors, while at the same time providing the data to requesting applications and users as often as possible. Further, each client 151 may represent a business user or system interacting or working with one or more of the BPMS server 103, its corresponding business process models 115 or process binaries 118, 121, and/or the central transactional component 148. Users at a particular client 151 may attempt to execute and perform tasks associated with the underlying business process and business process application 127, where appropriate. Additionally, a user at the particular client 151 may be an administrator authorized to modify one or more optimization rules 124 or other settings associated with the BPMS server 103 and its components, as well as the central transactional component 148. Environment 100 is an example, and in alternative implementations, the elements illustrated in FIG. 1 may be included in or associated with different and/or additional servers, clients, networks, and locations other than those as shown. For example, one or more of the components illustrated within the BPMS server 103 may be located in multiple or different servers, cloud-based networks, or other locations accessible to the BPMS server 103 (e.g., either directly or indirectly via network 145).

In general, the BPMS server 103 is any server that stores and executes one or more business process applications 127. For example, the BPMS server 103 may be a Java 2 Platform, Enterprise Edition (J2EE)-compliant application server that includes Java technologies such as Enterprise JavaBeans (EJB), J2EE Connector Architecture (JCA), Java Messaging Service (JMS), Java Naming and Directory Interface (JNDI), and Java Database Connectivity (JDBC). In some instances, the BPMS server 103 may store a plurality of various other applications, while in other instances, the BPMS server 103 may be a dedicated server meant to store and execute a particular business process application 121 and its related functionality, including that associated with the process model compiler 130. In some instances, the BPMS server 103 may comprise a web server or be communicably coupled with a web server, where one or more of the business process applications 127 associated with the BPMS server 103 represent web-based (or web-accessible) applications accessed and executed through requests and interactions received on the client 151, executing a client application 163 operable to interact with the programmed tasks or operations of the corresponding business process application 127.

At a high level, the BPMS server 103 comprises an electronic computing device operable to receive, transmit, process, store, or manage data and information associated with the environment 100. The BPMS server 103 illustrated in FIG. 1 can be responsible for receiving application requests from one or more clients 151 (as well as any other entity or system interacting with the BPMS server 103, including desktop or mobile client systems), responding to the received requests by processing said requests in the associated business process application 127, and sending the appropriate responses from the business process application 127 back to the requesting client 151 or other requesting system. The business process application 127 can also process and respond to local requests from a user locally accessing the BPMS server 103. Accordingly, in addition to requests from the clients 151 illustrated in FIG. 1, requests associated with a particular business process application 127 may also be sent from internal users, external or third-party customers, and other associated business applications or business processes, as well as any other appropriate entities, individuals, systems, or computers. In some instances, the business process application 127 may be a web-based application executing functionality associated with a networked or cloud-based business process. Still further, the BPMS server 103 may respond to requests from clients 151 or other entities, including those accessing the BPMS server 103 directly, the requests requesting optimization of one or more business process models 115 associated with the BPMS server 103.

As used in the present disclosure, the term “computer” is intended to encompass any suitable processing device. For example, although FIG. 1 illustrates a single BPMS server 103, environment 100 can be implemented using any number of BPMS servers, as well as computers other than servers, including a server pool. Indeed, the BPMS server 103 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, the illustrated BPMS server 103 may be adapted to execute any operating system, including Linux, UNIX, Windows, Mac OS, or any other suitable operating system.

In the illustrated implementation of FIG. 1, the BPMS server 103 includes an interface 106, a processor 109, a memory 112, a business process application 127, a process model compiler 130, and a BPM runtime 142 (which may be a runtime portion of the business process application 127 in some implementations, and/or may act as an infrastructure supporting and managing the execution of the at least a part of the business process application 127). In some instances, the BPMS server 103 and its illustrated components may be separated into multiple components executing at different servers and/or systems. Thus, while illustrated as a single component in the example environment 100 of FIG. 1, alternative implementations may illustrate the BPMS server 103 as comprising multiple parts or portions accordingly.

FIG. 1 depicts a server-client environment, but could also represent a cloud-computing network based on particular deployment options. Various other implementations of the illustrated environment 100 can be provided to allow for increased flexibility in the underlying system, including multiple BPMS servers 103 performing or executing one or more additional or alternative instances of the business process application 127, as well as other applications associated with or related to the business process application 127, including those illustrated as included as part of the business process application 127 and/or BPM runtime 142. In those instances, the different BPMS servers 103 may communicate with each other via a cloud-based network or through the connections provided by network 145. In other instances, portions of the illustrated process model compiler 130 may also be distributed among additional components, as well as included in the inherent functionality of the BPMS server 103, the business process application 127, the BPM runtime 142, or any other suitable location.

The interface 106 is used by the BPMS server 103 to communicate with other systems in a client-server or other distributed environment (including within environment 100) connected to the network 145 (e.g., one of the clients 151, as well as other systems communicably coupled to the network 145). The interface 106 generally comprises logic encoded in software and/or hardware in a suitable combination and operable to communicate with the network 145. More specifically, the interface 106 may comprise software supporting one or more communication protocols associated with communications such that the network 145 or the interface's hardware is operable to communicate physical signals within and outside of the illustrated environment 100.

Generally, the BPMS server 103 may be communicably coupled with a network 145 that facilitates wireless or wireline communications between the components of the environment 100 (i.e., between the BPMS server 103 and one or more clients 151 and/or the central transactional component 148), as well as with any other local or remote computer, such as additional clients, servers, or other devices communicably coupled to network 145, including those not illustrated in FIG. 1. In the illustrated environment, the network 145 is depicted as a single network, but may be comprised of more than one network without departing from the scope of this disclosure, so long as at least a portion of the network 145 may facilitate communications between senders and recipients. In some instances, one or more of the components associated with the BPMS server 103 may be included within the network 145 as one or more cloud-based services or operations.

The network 145 may be all or a portion of an enterprise or secured network, while in another instance, at least a portion of the network 145 may represent a connection to the Internet. In some instances, a portion of the network 145 may include a portion of a cellular or mobile data network or other network capable of relaying short message service (SMS) or multimedia messaging service (MMS) messages, as well as other suitable mobile data messaging. In some instances, a portion of the network 145 may be a virtual private network (VPN). Further, all or a portion of the network 145 can comprise either a wireline or wireless link. Example wireless links may include 802.11a/b/g/n, 802.20, WiMax, 3G, 4G (i.e., LTE), and/or any other appropriate wireless link. In other words, the network 145 encompasses any internal or external network, networks, sub-network, or combination thereof operable to facilitate communications between various computing components inside and outside the illustrated environment 100. The network 145 may communicate, for example, Internet Protocol (IP) packets, Frame Relay frames, Asynchronous Transfer Mode (ATM) cells, voice, video, data, and other suitable information between network addresses. The network 145 may also include one or more local area networks (LANs), radio access networks (RANs), metropolitan area networks (MANs), wide area networks (WANs), all or a portion of the Internet, and/or any other communication system or systems at one or more locations.

As illustrated in FIG. 1, the BPMS server 103 includes a processor 109. Although illustrated as a single processor 109 in the BPMS server 103, two or more processors may be used in the BPMS server 103 according to particular needs, desires, or particular embodiments of environment 100. The processor 109 may be a central processing unit (CPU), a blade, an application specific integrated circuit (ASIC), a field-programmable gate array (FPGA), or another suitable component. Generally, the processor 109 executes instructions and manipulates data to perform the operations of the BPMS server 103 and, specifically, the functionality associated with the corresponding business process application 127, the BPM runtime 142, and/or the process model compiler 130. In one implementation, the server's processor 109 executes the functionality required to receive and respond to requests and instructions from the client 151 and/or requests and responses from the central transactional component 148, as well as the functionality required to perform the operations of the associated business process application 127, BPM runtime 142, and process model compiler 130, among others.

Regardless of the particular implementation, “software” may include computer-readable instructions, firmware, wired or programmed hardware, or any combination thereof on a tangible and non-transitory medium operable when executed to perform at least the processes and operations described herein. Indeed, each software component may be fully or partially written or described in any appropriate computer language including C, C++, Java, Visual Basic, ABAP, assembler, Perl, any suitable version of 4GL, as well as others. It will be understood that while portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components, as appropriate. In the illustrated environment 100, each processor 109 executes the corresponding business process application 127, BPM runtime 142, and process model compiler 130 stored on the associated BPMS server 103. In some instances, a particular BPMS server 103 may be associated with the execution of two or more business process applications 127 (and other related components), as well as one or more distributed applications executing across two or more BPMS servers 103.

At a high level, each business process application 127 is any application, program, module, process, or other software that may execute, change, delete, generate, or otherwise manage information associated with a particular BPMS server 103, and in some cases, a business process or set of business processes performing and executing business process-related steps and events, where the business processes and their operations are designed and described in a corresponding business process model 115. Each business process model 115 may be defined in an appropriate syntax or format, such as BPMN. The business process models 115 can in some instances be executed directly through use of the BPM runtime 142, which can interpret the models and execute the corresponding business processes accordingly. In other instances, the business process models 115 may be compiled into an appropriate process binary 118, 121 for the BPM runtime 142 to interpret and execute. The process model compiler 130 can, as described below, optimize a particular business process defined in a corresponding business process model to increase efficiency and process-related KPIs, creating one or more optimized process binaries 121 that are then executable in the BPM runtime 142. Other non-optimized process binaries 121 can also be executed in the BPM runtime 142. To realize the benefits of the process model compiler's optimization, the business process model 115 associated with the non-optimized process binary 118 can be re-compiled by the process model compiler 130 to create a new, optimized process binary 121 that provides the benefits and advantages described herein.

In particular, business processes communicate with other users, applications, systems, and components to send and receive events, while processing the data associated with these communications to perform one or more operations and tasks. In some instances, a particular business process application 127 may operate in response to and in connection with one or more requests received from an associated client 151 or other remote client. Additionally, a particular business process application 127 may operate in response to and in connection with one or more requests received from other business process applications 127, including a business application associated with another BPMS server 103 (not illustrated) and/or a client application 163 executing on a particular client 151. In some instances, each business process application 127 may represent a web-based application accessed and executed by remote clients 151 via the network 145 (e.g., through the Internet, or via one or more cloud-based services associated with the business process application 127). Further, while illustrated as internal to the BPMS server 103, one or more processes associated with a particular business process application 127 may be stored, referenced, or executed remotely. For example, a portion of a particular business process application 127 may be a web service that is remotely called, while another portion of the business process application 127 may be an interface object or agent bundled for processing at a remote system (not illustrated) or client 151 (e.g., the client application 163). Moreover, any or all of a particular business process application 127 may be a child or sub-module of another software module or enterprise application (not illustrated) without departing from the scope of this disclosure. Still further, portions of the particular business process application 127 may be executed or accessed by a user working directly at the BPMS server 103, as well as remotely at a client 151.

The business processes performed by the business process application 127 may include actions defined in one or more non-optimized process binaries 118 and/or one or more optimized process binaries 121, each illustrated as stored in memory 112. Memory 112 of the BPMS server 103 stores data and program instructions. Memory 112 may include any memory or database module and may take the form of volatile or non-volatile memory including, without limitation, magnetic media, optical media, random access memory (RAM), read-only memory (ROM), removable media, or any other suitable local or remote memory component. Memory 112 may store various objects or data, including classes, frameworks, applications, backup data, business objects, jobs, web pages, web page templates, database tables, process contexts, repositories storing services local to the BPMS server 103, and any other appropriate information including any parameters, variables, algorithms, instructions, rules, constraints, or references thereto associated with the purposes of the BPMS server 103, its business process application(s) 127, the process model compiler 130, and the BPM runtime 142. In some implementations, including a cloud-based system, some or all of memory 112 may be stored remotely from the BPMS server 103, and communicably coupled to the BPMS server 103 (i.e., via network 145). As illustrated, memory 112 includes the set of business process models 115, the set of non-optimized process binaries 118, the set of optimized process binaries 121, and one or more optimization rules 124.

The business process models 115 can provide an illustration and design-time definition of one or more process steps, operations, and various criteria to be performed by and during execution of a particular business process. In the example of the present disclosure, the business process models 115 can be defined in a common business modeling language, such as BPMN or business process execution language (BEPL), among other suitable representations. The models 115 can be created by a business user, technical expert, or other business process-related user, and can define one or more interactions between systems and components to complete particular tasks. In many instances, business process models 115 can illustrate and define communications that are to be sent between two or more components interacting within the business process.

The process binaries 118, 121 represent compiled versions of one or more business process models 115. In some instances, BPMS servers 103 and their business process applications 127 do not execute business process models 115 themselves, but instead process binaries 118, 121 that are created after compiling the underlying, corresponding business process model 115. The business process application 127, using its related BPM runtime 142, can execute the one or more process binaries 118, 121 to perform the actions, events, and process steps of the corresponding business process model 115. Process binaries typically differ from the underlying modeling language (e.g., BPMN) even though a BPMS runtime might also interpret the process model directly. Reasons for using a process binary format that differs from the process model are (1) performance, (2) reuse, and (3) extensibility. With regard to performance, typically process binaries are optimized to yield the best performance when executing a process, as opposed to merely interpreting a business process model. The same is true for other programming languages where the program binaries offer a better performance than interpreting the program source code directly. Reuse of the underlying runtime infrastructure where one and the same infrastructure (e.g., a Java Virtual Machine and a J2EE application server on top) may be used to execute a plethora of different application types, including business processes, user interfaces, business rules, Web services, etc. With regard to extensibility, a BPMS runtime may need to offer broader functionality than merely executing processes. That may include abilities to execute functionality that is often used in conjunction with business processes, such as business rules, complex event processing, status and action model tracking, business activity monitoring, and others. In practice, BPMS runtimes differ greatly in terms of the format of the process binaries. Some BPM offerings use another BPM standard, such as BPEL, as their binary format.

Generally, the process binaries 118, 121 derived from a particular business process model 115 comprise complex, highly structured sets of information that are executable to perform the business processes defined within the underlying business process model 115. When a process binary is generated after compiling the corresponding process model 115, the resulting process binary 118 or 121 can be stored in memory 112. In some instances, one or more non-optimized process binaries 118 may have been compiled prior to adding the functionality associated with the described optimizations. In those instances, the corresponding business process model 115 can be re-compiled with the process model compiler 130 using the described enhancements and functionality to create the optimized process binaries 121. In some instances, the optimized process binaries 121 can replace the non-optimized versions 118 stored prior to the re-compile.

The illustrated optimization rules 124 can define specific rules, algorithms, and preferences for optimization associated with the illustrated solution, and can be accessed and used by the process model compiler 130 at compile-time to determine the particular optimizations and/or level of optimizations to apply. For example, newly created transactional boundaries can be limited to a particular number of process steps in one instance. In other instances, additional comparisons and evaluations can be defined, including rules determining whether a particular optimization should be applied based on an amount of corresponding overhead that may be added by the optimization. If the overhead to be added reaches a certain threshold, the optimization may not be performed based on a defined rule or parameter in the optimization rules 124. Administrators at the client 151 or internal to the BPMS server 103 may have authorization to modify the optimization rules 124 as appropriate (via network 145).

The BPM runtime 142 is also executed by the processor 109. The BPM runtime 142, as described above, can be used to execute one or more business process applications 127, as well as process binaries 118, 121. In some instances, the BPM runtime 142 can execute instances of non-compiled business process models 115. The BPM runtime 142 can interpret and execute the applications and processes to provide a suitable runtime environment for the underlying operations and applications at the BPMS server 103. In some instances, the BPMS server 103 and may include a process repository to store and manage versioned process binaries. In such instances, two versions of process binaries for the same process model may co-exist at the BPMS server 103. For instances, there may be both optimized and non-optimized versions of the process binary for the same process model. The BPM runtime 142 can keep these versions apart and support process instances of both versions simultaneously.

The processor 109 also executes the process model compiler 130. The process model compiler 130 is operable to access, analyze, and compile business process models 115 into executable process binaries 118, 121 or other executable objects or code, as appropriate. In general, the process model compiler 130 can translate the process models 115 and other source files into object code, process binaries, and other executable formats of the process model. In the illustrated example, the process model compiler 130 receives, as input, the business process models 115, and generates, as output, the process binaries 118, 121. In some instances, the process model compiler 130 can perform the optimization operations described herein. In those instances, the process model compiler 130 can generate the optimized process binaries 121. If the process model compiler 130 does not perform the optimization operations, the process model compiler 130 generates the non-optimized process binaries 118. In some instances, one or more of the non-optimized process binaries 118 may have been created prior to the process model compiler's access to the optimization operations. In those instances, the respective process models 115 can be re-compiled to provide a corresponding updated and optimized process binary 121.

The optimization operations of the process model compiler 130 can be performed by one or more of the illustrated modules within the process model compiler 130: a traversal module 133 and an optimization module 136. In the illustrated example, the modules 133, 136 work together to perform the optimization operations within the process model compiler 130, in addition to the inherent functionality previously included within the compiler 130 itself. While FIG. 1 is an example illustration, alternative implementations may include an instance where one module performs the described operations, an instance where two or more modules perform the operations, or an instance where the process model compiler's inherent functionality includes the operations performed by the components, as well as any other suitable combination of modules and functionality.

The traversal module 133 can perform the operations associated with traversing a particular process model 115 being compiled at the process model compiler 130. The traversal module 133 can begin at a particular start event associated with the process model 115, and continue through the process model 115 to identify sequential process steps. When the process model 115 is implemented in BPMN, the various process steps may include, but are not limited to, Catch events, Throw events, activities, and gateways, the gateways including branching process steps that separate a process's flow into at least two branches, and merging process steps that combine at least two branches in a process flow into one. Generally, “Catch events” and “Throw events” consume or produce “events” having some “trigger type.” The events include messages, signals, error events, timer events, complex events, and others. Start events are a specific type of Catch events, and end events are specific types of Throw events. There are also intermediate events which may either be Catch events or Throw events. The traversal module 133 can work interactively with the illustrated optimization module 136 to analyze and identify subsets of process steps within the process model 115 that can be combined into a single transaction. The optimization module 136 can perform modifications to the transactional logic and definitions within the compiled process binary 121, allowing for two or more process steps to be combined into one transaction where appropriate.

Generally, the process model 115 is recursively traversed at the start event and follows the defined control flow through the process, or downstream. For any process branch, the traversal module 133 and/or the optimization module 136 track the current transactional boundary (or in BPMN-based implementations, transactional sub-process) and successively visits the process steps on that branch. Any sequential non-branching and non-merging synchronous and outbound asynchronous process step may be joined, or be added to, a transactional boundary of the current process branch. In some instances, this may mean that the process step is connected to the last process step inside the current transactional boundary by, for example, a sequence connector. If no such process steps exist, the current process step can mark the beginning of a new transactional boundary.

An inbound asynchronous process step, such as an Intermediate Catch Message Event in BPMN, closes the current transactional boundary, if one exists, creates a new transactional boundary, and connects the previous transactional boundary to the new transactional boundary, making the current process step (i.e., the inbound asynchronous process step) the new transactional boundary's first entity. Alternatively, a branching gateway closes the current transactional boundary and connects the current transactional boundaries' outbound sequence connector to the gateway, which can reside outside the current transactional boundary. Each branch originating off the branching gateway can then be recursively traversed and analyzed. In still another example, a merging gateway can cause the transactional boundaries of the inbound branches to be closed, and connects those inbound branches' outbound sequence connectors to the merging gateway, and can then call this procedure for the following outbound branch after the merge. In some instances, any transactional boundaries containing only a single process step after the traversal and optimization operations can be replaced by the corresponding single process step.

Generally, the described optimizations, where two or more process steps are added to a single transaction (for example, a transactional sub-process in BPMN), and the determination as to which steps should be combined, are based on the transaction life cycle of the process steps. In other words, a critical determination can be made based on the ownership of the life cycle for a particular component. For example, where a process model includes two or more sequential activities, those activities may be able to be combined into a single transaction. If, however, an incoming message event follows those activities, the incoming message event may not be combined into the transaction, as the life cycle of the incoming message event is separate from the previous sequential activities. An incoming message can be received at any time based on external action. Such an event does not necessarily occur within a suitable timeframe after the previous sequential activities, and thus cannot be combined into a single transaction. Similarly, merging gateways cannot be paired with a previous set of sequential activities, as the merge action may receive the results from the previous set of sequential activities prior to receiving the results or output from the other branches to be combined at the merging gateway.

Once the traversal of the process model 115 (or a particular portion thereof) is complete, the process model compiler 130, or a suitable component or module, applies the identified optimizations to be made to the process model 115 during compilation, and can generate the appropriate optimized process binary 121. The optimized process binary 121 can be stored or sent to memory 112. Prior to compilation, and during the traversal and optimization identification action, the process model compiler 130 can refer to the optimization rules 124 for specific rules and guidelines for applying particular optimizations and transformations. In general, the transactional optimization described herein and subsequent compilation does not change the underlying process model 115, but instead creates a new or updated process binary 121 associated with the underlying process model 115. In some instances, the results of the modifications and changes to the underlying process model can be provided and/or presented to a technical user or business process expert, including an explanation of the optimizations performed by the compiler, thereby allowing those users to understand the impact of certain modeling practices exploited by the compiler.

The central transactional component 148 may include one or more databases storing business process-related information and data, and accessed in order to perform the operations associated with an executing business process, business process application 127, and/or process binary 118, 121. Alternatively, the central transactional component 148 may also be a middleware messaging component operable to exchange messages and information between various systems, BPMS servers 103, clients 151, and/or external databases. The central transactional component 148 may be shared by a plurality of systems, such that attempts to access portions of the information may occur at the same time. The central transactional component 148 can apply a suitable concurrency control mechanism, often based on a particular locking scheme, to protect from inconsistent data manipulation. The transactional optimizations performed by the process model compiler 130, as described above, can assist in protecting the integrity of the data within or associated with the central transactional component 148.

The illustrated environment 100 includes one or more clients 151. The clients 151 may be associated with a particular BPMS server 103, or the clients 151 may generally execute in environment 100, capable of interacting with the BPMS server 103. Each client 151 may be any computing device operable to connect to or communicate with at least one of the BPMS servers 103 using a wireline or wireless connection, via the network 145, or another suitable communication means or channel. In some instances, the client 151 may be a part of or associated with a business process involving one or more of the business process applications 127. In general, each client 151 includes a processor 157, an interface 154, a client application 163, a graphical user interface (GUI) 166, and a memory 160. In general, the client 151 comprises an electronic computer device operable to receive, transmit, process, and store any appropriate data associated with the environment 100 of FIG. 1. It will be understood that there may be any number of clients 151 associated with, or external to, environment 100. For example, while illustrated environment 100 includes a single client 151, alternative implementations of environment 100 may include multiple clients 151 communicably coupled to the one or more of the systems illustrated. In some instances, one or more clients 151 may be associated with administrators of the environment, and may be capable of accessing and interacting with the settings and operations of the business process application 127, the BPM runtime 142, the process model compiler 130 and its associated optimization rules 124, the process models 115, and/or other components of the BPMS server 103. Additionally, there may also be one or more additional clients 151 external to the illustrated portion of environment 100 capable of interacting with the environment 100 via the network 145. Further, the terms “client” and “user” may be used interchangeably as appropriate without departing from the scope of this disclosure. Moreover, while each client 151 is described in terms of being used by a single user, this disclosure contemplates that many users may use one computer, or that one user may use multiple computers.

The GUI 166 associated with each client 151 may comprise a graphical user interface operable to, for example, allow the user of a client 151 to interface with at least a portion of the business process application 127 and its associated operations and functionality. Generally, the GUI 166 provides the particular user with an efficient and user-friendly presentation of business data provided by or communicated within the system. The GUI 166 may comprise a plurality of customizable frames or views having interactive fields, pull-down lists, and buttons operated by the user. For example, the GUI 166 may provide interactive elements that allow a user to interact with a particular business process application 127 or BPMN runtime 142, as well as other components within and/or external to environment 100. The different portions of the application server's functionality may be presented and accessible to the user through the GUI 166, such as through a client application 163 (e.g., a web browser). Generally, the GUI 166 may also provide general interactive elements that allow a user to access and utilize various services and functions of a particular business process application 127. In some instances, the client application 163 may be used to access various portions of different BPMS servers 103 or business applications 127. In some instances, the client application 163 may be used to access (and the GUI 166 used to view) information retrieved from the memory 112 (i.e., a business process model 115 and/or a process binary 118, 121) via the business process application 127 and/or BPM runtime 142. Alternatively, the client application 163 may be used to access and manipulate the settings associated with the optimization rules 124 and the process model compiler 130. In some instances, the client application 163 may be an agent or client-side version of the business process application 127. The GUI 166 may present the information of the client application 163 for viewing and interaction. In general, the GUI 166 is often configurable, supports a combination of tables and graphs (bar, line, pie, status dials, etc.), and is able to build real-time portals, where tabs are delineated by key characteristics (e.g., site or micro-site). Therefore, the GUI 166 contemplates any suitable graphical user interface, such as a combination of a generic web browser, intelligent engine, and command line interface (CLI) that processes information in the platform and efficiently presents the results to the user visually.

As used in this disclosure, each client 151 is intended to encompass a personal computer, touch screen terminal, workstation, network computer, kiosk, wireless data port, smart phone, personal data assistant (PDA), one or more processors within these or other devices, or any other suitable processing device. For example, each client 151 may comprise a computer that includes an input device, such as a keypad, touch screen, mouse, or other device that can accept user information, and an output device that conveys information associated with the operation of one or more application servers 103 and their functionality and/or the client 151 itself, including digital data, visual information, or the GUI. Both the input and output device may include fixed or removable storage media such as a magnetic storage media, CD-ROM, or other suitable media, to both receive input from and provide output to users of client 151 through the display, namely, the GUI 166. The client's processor 157, interface 154, and memory 160 may be similar to or different from those described in connection with the other components illustrated in FIG. 1, although alternative implementations of one or more of these components may be used, as well as implementations where additional components may also be included.

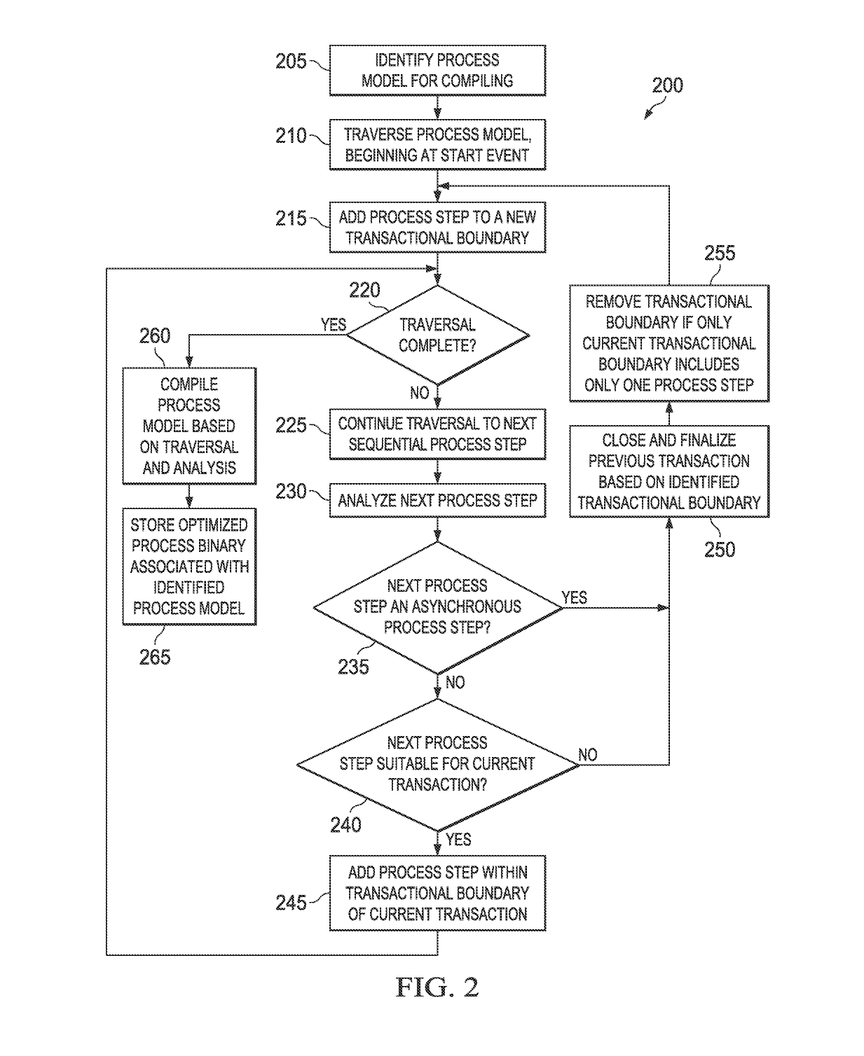

FIG. 2 is a flowchart of an example method 200 for traversing and transactionally optimizing a business process model at compile-time. For clarity of presentation, the description that follows generally describes method 200 in the context of environment 100 illustrated in FIG. 1. However, it will be understood that method 200 may be performed, for example, by any other suitable system, environment, or combination of systems and environments, as appropriate.

At 205, a process model is identified to be compiled into an executable object, such as a process binary. In some instances, the process model may have previously been compiled, where the prior compiled version of the process model was not transactionally optimized by the operations of method 200. At 210, the identified process model is traversed, beginning at a start event of the process model. In some instances, the optimization operations of method 200 may be performed on particular portions of the process model beginning at portions other than the start event and/or ending prior to the corresponding end event of the process model.

At 215, the first process step is added to a new transactional boundary. Restated, the first process step forms the lower boundary of the current transactional boundary or context. In one example, the transactional boundaries can be defined as transactional sub-processes in BPMN. At 220, a determination is made as to whether the traversal is complete. In some instances, this may be a determination as to whether additional process steps are included in the process model, while in other instances, a determination may be made as to whether the current optimization end event or other activity has been reached, for example, where only a portion of the process model is being optimized. If the traversal and optimization process is complete, method 200 continues at 260. If, however, the process is not complete, method 200 continues at 225, where the traversal continues to the next sequential process step within the process model, and at 230, where that process step is analyzed.

At 235, a determination is made as to whether the next process step is an asynchronous process step, such as an incoming message event. As asynchronous, for instance, inbound process steps (corresponding to the in-only and robust-in-only message exchange patterns) cannot be included in the current transaction due to potential lag and associated issues, as well as because the BPMS does not control the transaction within which the event (i.e., a message) is delivered to the BPMS, those process steps will be excluded from the current transactional boundary. It should be noted that a process step that sends a message or event may join the current transaction, as the sending event is performed relatively synchronously to the previously-included process step. Therefore, if the next process step is asynchronous, then method 200 continues at 250, beginning the process of closing the current transaction and opening a new transaction. If not asynchronous, then method 200 continues to 240, where a determination is made as to whether the next process step is suitable for the current transactional boundary. In some instances, this may include a determination as to whether the next step is a merging or branching gateway, as well as other potential process steps as defined by a set of optimization rules or a lookup table containing decision criteria for a particular optimization scenario. In some instances, the size of particular transactions may be limited to a certain number of process steps, such that the determination at 240 includes a determination as to whether the maximum threshold for process steps has been exceeded. Being suitable for inclusion in a particular transactional boundary may also be based on whether the process step is asynchronous or not. In those instances, the determinations of 235 and 240 could be merged into a single decision which may use a lookup table of decision criteria and/or a set of optimization rules to evaluate the process step.

If the next process step is not suitable for the current transaction as determined at 240, then method 200 continues at 250. The current transactional boundary and transactional definition is closed and finalized at 250, including the various steps that have previously been included within the current transaction. At 255, the transactional boundary (such as a transactional sub-process) can optionally be removed from a transaction that includes a single process step. For instance, when represented as a transactional sub-process, a transactional sub-process containing a single process step would be removed, leaving the contained process step “as is.” Method 200 would then continue to 215, where a new transactional boundary would be created for the next process step. Returning to 240, if the next process step is determined to be suitable to be included within the current transactional boundary, then method 200 continues at 245, where the process step is added within the transactional boundary of the current transaction. Once added, method 200 returns to 220, where the traversal and analysis moves to the next sequential process step.

Returning to 220, where the traversal is complete, method 200 moves to 260. At 260, the process model is compiled based on the traversal, analysis, and optimizations defined by the prior operations, such that binary code is generated out of the augmented/altered/optimized process model resulting from the algorithm of method 200. Specifically, the process model is compiled into an executable format, such as a process binary, which defines and includes the various transactional boundaries of various process steps. By combining these process steps within the transactional boundary, the executed process binary will be optimized as described above. At 265, the optimized process binary associated with the identified process model is stored for use and execution. The optimized process binary can be semantically identical to the underlying business process model, such that the results of the operations performed by the optimized process binary will be the same as those defined within the business process model.

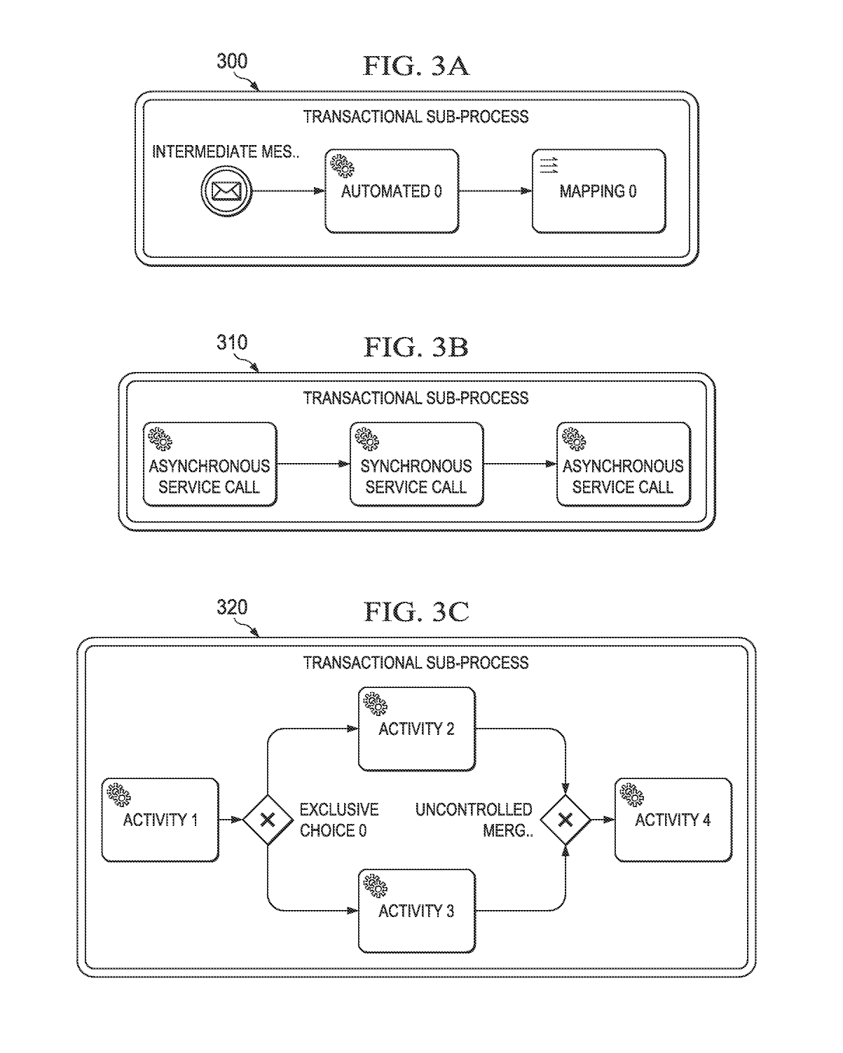

FIGS. 3A-C illustrate examples of optimized process steps combined into transactional sub-processes in a BPMN environment. The example 300 of FIG. 3A illustrates how a sequence of an intermediate message event, a call activity, and a mapping activity are combined into a single transaction as represented by the surrounding transactional sub-process in BPMN notation. Because the process steps can be triggered sequentially and without delay, the transactional sub-process is effective at combining and optimizing the steps. Example 310 of FIG. 3B illustrates a set of operations each making outbound asynchronous and synchronous service calls. Assembling the activities into a single transaction is feasible, as no violations of consistency criteria are caused by the combination. In order to not interfere with progress of parallel process branches, transactional scope extension may be limited to plain sequences of process steps without any merging or splitting of branches in a business process that needs to happen in a separate transaction. Conceptually, however, exclusive branching (i.e., an XOR split) and non-synchronizing merging of branches (XOR merge) can be subject to a transactional scope extension. FIG. 3C illustrates an example 320 of such an instance. Because the split is an exclusive split (i.e., only one of the parallel branches will be taken), and because the merge is an uncontrolled merge (i.e., where the process continues when any branch reaches the merge, and does not wait to synchronize with another branch), they can both be included within the transactional boundary. In some instances, a set of optimization rules can define which types of optimization are allowed and/or available. Similar to example 320, parallel branches can generally be subjected to transactional scope expansion separately, allowing for both branches to each be a single transaction, even where both branches include multiple process steps. In some instances, the parallel branches may not be executed simultaneously in two threads, but sequentially in a single thread.

In many instances, a determination as to when a particular optimization technique may be useful and/or necessary is required prior to applying that optimization. In many instances, the benefits associated with a particular optimization may be outweighed by the environment in which a particular system is or will operate. In those instances, it may be placed into a system administrator's hands to determine which optimizations should be applied to a particular BPM domain and its process models. To remove the decision from the administrators hands, and to provide an automatic solution, an adaptive compiler infrastructure is provided herein. In other words, an optimization pipeline may be added between the compiler's front-end and back-end stages.

The optimization pipeline can be separated into a logical optimization stage and a physical optimization stage. Logical optimizations alter the underlying process model, optionally creating alternate intermediate representations of the process model to reduce potential issues with the underlying business process steps, increase efficiency, or otherwise optimize the process model itself. The logical optimizations produce semantically equivalent, yet improved, process models that adhere to the same base metamodel (i.e., BPMN) as the original process model. In effect, logical optimizations are independently applicable in the contexts of different BPM suites. Various logical optimizations exist, affecting both the control flow and data flow aspects of the underlying process model. Examples of logical optimizations include (1) sequentializing resource contentions, (2) parallelizing independent process steps, (3) transaction scope expansion, (4) data mapping redundancy elimination, and (5) premature correlation scope termination.

In contrast, physical optimizations assume specific programming models and runtime representations of concrete BPMS runtimes. Physical optimizations can be applied after an intermediate code generation phase, where a process model that adheres to a BPM design-time metamodel is transformed into the process binary as described above. The process binary is then manipulated by various physical optimization phases, including a one-step process termination and batched multiple instance activity parallelism.

The various potential logical and physical optimizations may address one or more diverse goals specific to the BPM domain. The particular goals for optimizations may include, but are not limited to, reducing process turnaround times, increasing process throughput and fair progress among concurrent processes, and reducing the static footprint, dynamic footprint, transaction load, and frequency of resource contentions of the executable process model or process binary, among others. The adaptive compiler infrastructure described herein provides an automatic approach to select an optimization pipeline based on information extracted from the underlying information technology (IT) infrastructure. The IT infrastructure information may include data on the target IT landscape (e.g., development, quality assurance, production, etc.), the deployment options (e.g., cloud-based or on-premise), the prevalent usage type of the process model (e.g., system-centric processes vs. human-driven processes), and the average load on the underlying computing resources, among others. In effect, the adaptive compiler infrastructure defined herein lowers the total cost of ownership (TCO) by analyzing the environment of the process model's execution and determining how the particular process model and/or process binary should be optimized to best fit the runtime context, such that non-technical users are unburdened from the tasks of choosing appropriate optimization goals and making the choice of corresponding optimization phases and their order.

The adaptive compiler differs from a traditional optimizing compiler infrastructure in that the adaptive compiler infrastructure described herein focuses on the BPM domain characterized by graphical modeling language, diverse runtime paradigms, and distinct optimization opportunities. The optimization is separated into a logical optimization and a physical optimization stage, where the logical optimization stage performs process model transformations yielding a semantically equivalent process model such that a particular BPMS infrastructure is not assumed. Further, the adaptive compiler adheres to a number of boundary conditions, including transparency, control, flexibility, versioning support, and orchestration capabilities, among others, that are specific to the BPM domain and do not necessarily exist in traditional compiler infrastructures. Moreover, the adaptive compiler supports a wide range of optimization goals covering both performance aspects and resource consumption aspects which are unlikely to be optimized in traditional compiler infrastructures, such as the number of transactions needed to execute a business process instance.

Similarly, query plan optimizers in database systems aim to restructure database queries and statements to yield better processing times. This is also different than the adaptive compiler infrastructure described herein. For instance, in relational database systems, query plan optimizers work on expressions in relational algebra, such as SQL statements, which are transformed into query plans using the physical operators of the underlying database systems (e.g., index scans, specific join algorithms, etc.). The adaptive compiler differs both in domain (i.e., database query processors v. BPMS runtimes) and the scope of optimization. Also, query plan optimizers yield a query plan that returns the correct result within acceptable answering times, while other constraints and optimization goals are not applicable.

Research into adaptive compilation is based on a multi-dimensional, non-linear optimization problem attempting to improve on a statically measurable optimization goal (e.g., number of CPU instructions, number of bit transformations, etc.) by heuristically searching for a good, yet not necessarily optimal, selection and ordering of different optimization phrases. The adaptive compiler described herein avoids the consequential downside of probing many different combinations of optimization phases by relying on an efficient lookup mechanism that selects the to-be-applied optimization phases, and their order, by (1) identifying various relevant characteristics of the IT landscape within which the BPMS is embedded and (2) the effects of the different optimization algorithms on the resulting optimization goals. In effect, multiple optimization goals may be addressed simultaneously with different priorities.

Further, existing compiler implementations differ from the described adaptive compilers by requiring optimization settings to be manually made which determine the optimization goal and the aggressiveness of the optimizations. In contrast, the adaptive compiler infrastructure of the present application avoids the resulting impact on the TCO and assumes a non-technical user that may not be qualified to perform such settings. Instead, the proposed adaptive compiler infrastructure takes advantage of the fact that a BPMS is part of a complex IT landscape that entails aspects such as deployment options, target landscapes, and other particular details and settings.

The adaptive compiler can be used for various purposes. For instance, the compiler can be used to compile business processes and process models such that the resulting process binaries are tuned to simultaneously support a number of BPM-specific optimization goals, such as those described above. Additionally, the adaptive compiler can support different types of models for business processes, including BPMN, event-driven process chains (EPC)s, BPEL, UML state charts, and others, as well as different types of process binaries. The logical optimization algorithms for different BPMSs from different vendors that use the same underlying model format or type can be reused, such as multiple vendors using BPMN-based models. In some instances, the selection and ordering of appropriate optimization algorithms for a particular business process or process model can be automatically performed based on information extracted from metadata and other setting repositories of the underlying IT landscape. Additionally, the TCO for automating business processes can be reduced by lowering the resource consumption characteristics for the IT landscape through optimizations, thus improving their performance and allowing more process instances to be executed on the same infrastructure, while still adhering to BPM-specific constraints.

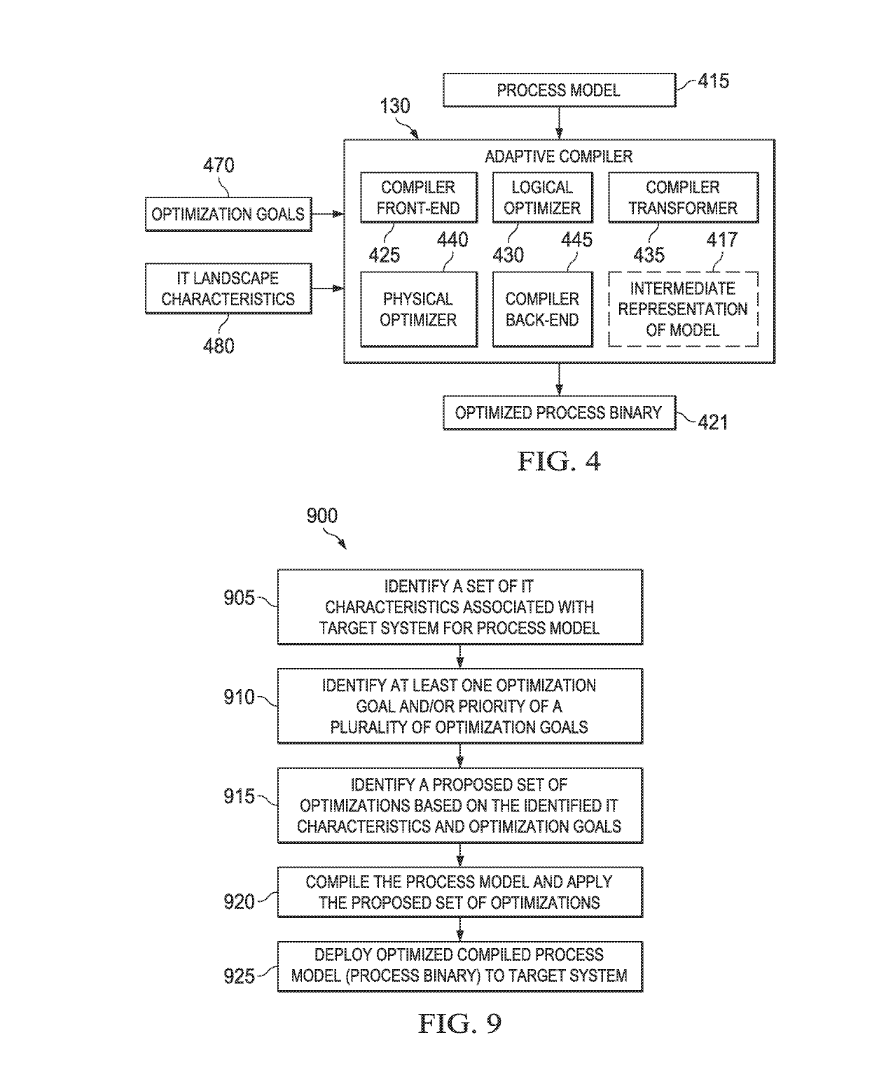

In some instances, the adaptive compiler infrastructure 130 can be devised into five principal stages, modules, or components, as illustrated in FIG. 4. In the first stage, the adaptive compiler's front-end analyzer 425 reads an input model 415 into a data structure that corresponds to some underlying metamodel (e.g., a BPMN 2.0 metamodel). That metamodel-based data structure (e.g., the process model) serves as the baseline intermediate representation that is used throughout successive stages of the compiler 130. These stages enrich the intermediate representation by augmenting the model with additional metadata that is needed for certain optimization or code generation phases. The model is a graphical intermediate representation, similar to an abstract syntax tree (AST) in traditional (textual) programming languages. In other words, the front-end 425 captures relevant information from the process model in a directed graph. In some instances, the front-end analyzer 425 may also identify one or more optimization goals 470, as well as the particular IT landscape characteristics 480 of the target system, using that information to identify the appropriate optimizations to be applied during compiling.

In the second stage, the logical optimizer 430 transforms the model that is produced by the front-end stage 425 into a semantically-equivalent model that adheres to the same metamodel, sequentially applying a pipeline of individual logical optimizations. While doing so, the logical optimizer 430 may have to enrich the model with additional metadata such as data dependency graphs, as well as other suitable information and data. The logical optimizer 430 generates an optimized process model 417 out of the original process model 415.

In the third stage, the transformer 435 compiles, or generates code representing, the model-based intermediate representation 417 that is produced by the logical optimizer 430 into an executable process binary. In doing so, the transformer 435 provides the foundation for successive physical optimization phases that operate on the process binary. The process binary augments the intermediate representation of the underlying model 415 accumulated in earlier phases such that successive phases may still access that metadata to perform their specific optimizations.

In the fourth stage, the physical optimizer 440 reads the intermediate representation 417 comprising the model from the front-end stage, the process binary from the transformer stage 435, and any other metadata accumulated by the logical optimizer stage 430. Similar to the logical optimizer 430, the physical optimizer 440 is devised into a pipeline of individual (physical) optimization phases which are sequentially applied. Each phase may, again, add further metadata to the intermediate representation 417, which is consumed by successive phases.

In the fifth stage, the back-end 445 generates file(s) for the concrete format for a specific target BPM runtime (i.e., the optimized process binary 421), such as CSV-encoded trigger networks, BPEL, JavaScript code, or any other suitable format, from the intermediate representation 417 that is produced by the physical optimizer 440 in the fourth stage.

Separating the optimization stage in between the front-end 425 and the back-end 445 into three distinct stages is unique to this adaptive compiler approach and is justified by (i) keeping the logical optimizer 430 and the intermediate representation format applicable to different BPM runtimes and (ii) providing for dedicated physical optimizations that are only applicable for certain BPM runtimes. Traditionally, compilers do not make that distinction but merely abstract the distinction from the input format (here, the BPM metamodel) and the output format (here, the process binary for a concrete BPM runtime) through their corresponding front-end 425 and back-end 445 stages. The former approach is suitable for most traditional programming languages (which, apart from their syntax, share many common concepts such as object orientation and polymorphism, conditionals, looping, modules, macros, etc.) and even more so for the target environment (e.g., CPU architectures such as IA32, x64, ARM, MIPS, etc. and managed byte codes like .Net CLI or Java byte code). In contrast to that, differences among BPM runtimes and, to some degree, BPM modeling languages, are much more pronounced, having fewer commonalities. For instance, there are BPM runtimes that are basically interpreters of some standardized BPM language such as BPEL or UML state charts. Obviously such interpreters would greatly differ from the runtime component of a proprietary runtime based upon event-condition-action (ECA) rules encoded in a RETE-like network (e.g., Trigger Networks) and custom action scripts. Other BPMS may choose a virtual machine (such as a Java VM) as their BPM runtime.

Compiling is subject to a number of boundary conditions that are specific to the BPM domain. Those boundary conditions are a consequence from virtues of following a model-driven BPM approach to automate real-life business processes. On the downside, they partially impose constraints on the applicability of certain optimization strategies. In particular, the following boundary conditions may apply to optimizing business process automation:

Transparency.

Unlike regular application binaries, executable business processes follow a “white box” approach. That is, business processes are based upon a process model whose internals are observable at runtime. The former characteristic is a fundamental difference to “black box” applications that merely expose their interfaces—both technical interfaces (i.e., service interfaces) and user interfaces—but that hide their internals.

For example, end users may debug (manually step through) a process, have the process' progress graphically visualized (by means of the original process model), and monitor the process' general status. In addition, the course of action that a process instance has made must be reflected in an audit log. Compiler optimizations must pay attention to those features and preserve a comprehensible relationship between a process' runtime status (like the positions of control flow tokens, data object values, etc.) to the underlying model.

Control.

Business processes do not only cater for transparency but also offer a wide array of control features that do not exist in traditional business applications, including basic operations such as cancelling, suspending, and resuming a business process instance. More sophisticated options include setting back a control flow token (i.e., to repeat one or a sequence of past process steps), skipping process steps, altering the process' data context, aborting single process branches, changing the process' priority, and others. Again, these control operations are typically based on a process model such that the same constraint as for the transparency boundary condition holds true: the course of action of a process' run must preserve its relation to the corresponding process model. While optimizations are free to alter, remove, or even rearrange process steps—performing one of the aforementioned operations on top of a process model (like to skip a process step) must still have a meaningful impact at runtime.

Flexibility.

One of the key advantages of business process management suites (BPMS) is to offer more flexibility to adapt processes to changing requirements. Various approaches exist to support flexibility, including:
Ad-hoc process changes where a running process instance is altered (like by adding or removing process steps) “on the fly” (i.e., without having to abort and re-start the affected process);
Process extensibility where new process “building blocks” (such as activities, sub-processes, user interfaces, data mappings, etc.) are plugged into existing process binaries through late binding mechanisms at predefined extension points; and
Process patch-ability where new versions of sub-processes are automatically incorporated into existing “parent process” definitions and instances which, thus, benefit from the changes (bug fixes, etc.) of the latest sub-process' version.

Most BPMSs offer incomplete support for the aforementioned flexibility use-cases. In effect, compile-time optimizations must merely make sure not to inhibit these use-cases. For instance, any extension points (tags on various process entities that mark them to be replaceable by other building blocks) must be preserved by optimization operations.

Versioning.

Business processes constitute long-running entities whose lifespan may last for days or even months. BPMSs often support versioning schemes where multiple versions of a business process may co-exist at runtime. In effect, the BPMS runtime may simultaneously run instances of different versions of the same business process. Process versioning affects an optimizing compiler in multiple ways. For one, compilers may adaptively choose the order of optimization phases such that the resulting process binaries may differ for successive compiler runs. Nevertheless, their version tags need to be identical, provided that the source model has not changed in between. A process binary's versioning tag is the sole criterion with which the BPMS lifecycle management component detects a new process version. Second, the compiler architecture must support independently versioned artifacts as such. The latter is not so much a requirement for individual optimization phases, but rather, an architectural prerequisite of the compiler infrastructure. That is, different reusable artifacts (such as data mappings, data types, sub-processes, user task definitions, etc.) are independently compiled and versioned where a business process that makes use of those artifacts “loops up” those artifacts from a runtime repository by means of their version tags. At compile time, compiler stages should not normally cross boundaries between independently versioned artifacts to adhere to the aforementioned mechanism.

Orchestration.

Business processes are often used in orchestration scenarios where the process provides the “glue” on top of existing services. That is, much of the process semantics are actually hidden in the orchestrated services. In effect, merely analyzing the data flow between individual process steps does not completely uncover all of their interactions. Instead, process steps calling external services (such as automated Web services, user tasks, etc.) may have “side effects” that are not explicit from the process model. In effect, intermediate representations of the business process, such as “dependency graphs” that merely capture the data flow dependencies, may not fully represent all dependencies between process steps. Optimization strategies that are based upon rearranging process steps need to pay careful attention to that aspect. A possible solution to this problem is to additionally consider other process step configuration settings (such as the step type, the external component it is interacting with, the message exchange pattern [asynchronous=stateful, synchronous=stateless] of remote service invocations, etc.) to assess whether or not hidden dependencies may exist.

Compile-time optimization may as such be subject to different optimization goals. Different optimization strategies may be targeted on specific goals, including the fact that a particular optimization strategy may even have a negative effect on some optimization goals. It is up to the scenario (e.g., system-centric processes, human-driven processes, etc.), the infrastructure characteristics (e.g., CPU resources, main memory resources, etc.) and other criteria to choose a suitable combination and order of optimization phases. When later introducing a number of selected BPM-specific optimization strategies, a qualitative assessment is provided of how the different optimization goals are affected. The non-exhaustive list of suggested optimization goals can be broken down into performance-oriented and resource consumption-oriented goals.

The performance-oriented goals may be based on time-centric optimizations. For instance, the end-to-end process turnaround time, which is the average duration of a single process' run (from start to completion), may be considered. The turnaround time is particularly important when processes autonomously perform computation (such as end-of-period data aggregations), or when processes govern the task routing of a real-life workflow where delays would cause disruptions for an end user's work. The overall process throughput, which is the number of process instances that can be completed in a given time frame, is a second goal. Process throughput is often critical for system-to-system integration where process instances continuously receive and process messages and must keep pace with incoming messages in order to avoid a denial of service (DoS) situation. Next, the fair progress goal seeks to balance the progress of all running process instances. Unlike process turnaround times and throughput, fair progress is a qualitative measure which aims at an equal distribution of runtime resources to all process instances and parallel branches within process instances.

The resource-oriented goals relate to the fact that process binaries also consume other resources apart from “time” (i.e., CPU cycles). In particular, main memory consumption and database accesses may be subject to optimization. The static footprint of a process binary denotes the size of the process binary in memory. As processes are long-running entities, optimizing the static memory consumption may help to fit more processes (and versions thereof) into main memory. The dynamic footprint of the process binary is the amount of main memory that is occupied by a process instance. Reducing the dynamic footprint is beneficial for two reasons: one, it helps to fit more process instances into main memory simultaneously (without having to evict one), and two, when being evicted or reloaded to/from some permanent storage (typically, the database), the input/output operations associated with the transfer have an impact on the performance of those lifecycle operations. The transaction load denotes the number of transactions on an underlying database system per time unit. Committing transactions is generally an expensive operation and it is often desirable to reduce the number of commits (independently from the number of bytes to be read from/written to the database). The resource contention likelihood identifies the probability of conflicting accesses to shared resources (data objects, process tokens, etc.), mostly caused by concurrent actions in process instances. Resource contentions may have a hard-to-predict negative impact on other performance measures, besides making non-desirable functional side effects (race conditions) more likely.

As described above, logical optimizations operate on the process model itself, optionally by augmenting the intermediate representation (i.e., the altered process model) by additional metadata such as control flow graphs, dependence graphs, etc. In particular, logical optimizations do not assume a specific target process runtime and, therefore, do not yet generate intermediate representations that depend on specific features of the target environment. Restated, logical optimizations perform model-to-model transformations, altering a source process model into a (semantically equivalent) target process model. The advantage of this approach lies in a general applicability of logical optimizations for heterogeneous process runtimes. The following examples of logical optimizations are not a complete and exhaustive list of transformations, although are representative of possible logical optimizations.

Logical optimizations can be separated into control flow and data flow-oriented optimizations, reflecting the portion of the process model that is primarily affected by those optimizations. Control flow-oriented optimizations alter the structure of a process model by rearranging, eliminating, or adding process steps. The example control flow-oriented optimizations can include sequentializing resource contentions, parallelizing independent process steps, and performing transactional scope extension (described in detail herein). The data flow-oriented optimizations can include data mapping redundancy elimination and premature correlation scope termination, among others.

BPMN makes it easy to perform process steps concurrently by splitting the control flow into parallel branches. The BPMN standard provides for inclusive gateways (i.e., “OR” splits/joins), parallel gateways (i.e., “AND” split/join), and complex gateways to both fork and synchronize concurrent threads of control executing process steps on separate branches. Concurrency can greatly improve process turnaround times by making progress on multiple process steps in parallel. On the downside, concurrency may lead to resource contentions (i.e., conflicting accesses to an exclusive resource happening in parallel) which adversely affects performance due to concurrency control mechanisms such as delayed lock acquisition (having to wait for a lock until it is freed up by another thread) and repetitive transaction rollbacks/retries (having to abort and re-schedule a transaction that failed to acquire a lock after waiting some time). Other than that, concurrent modifications of shared resources from parallel process branches may also lead to race conditions such as lost update phenomena (concurrent process steps that update the same resource where one process step overwrites the effects of the other process step).

The idea of sequentializing resource contentions is to (1) identify process steps on parallel branches (which may execute concurrently) performing conflicting accesses to shared resources and to (2) rearrange those process steps in an intent-preserving manner such that the conflict is resolved. The former considers both (1a) explicit and (1b) implicit conflicts such as concurrent data context accesses and external service invocations, respectively. The latter entails (2a) changing the order of process steps on a branch and (2b) moving process steps out of (i.e., front of or behind) the parallel branches.

Resolving conflicting resources, i.e., sequentializing resource contentions, addresses the issue of conflicting resources by identifying and resolving conflicting resource accesses from parallel process branches. Both explicit (internally managed) resources (e.g., mappings to/from, expressions atop data objects) and implicit (externally held) resources (e.g., business objects that are accessed and manipulated by service calls from business processes) are captured as “resource nodes” in a dependency graph, where process steps consuming (reading) and updating (writing) these resources are process step nodes having directed edges to the resource nodes, denoting read and write accesses.

By traversing all resource nodes and finding distinct pairs of process steps performing conflicting accesses to those resources, candidate process steps are identified. An efficient set of heuristics can be applied to assess whether two conflicting process steps may execute concurrently at runtime. That set of heuristics is based on a reachability property which (transitively) takes their process steps' inbound and outbound sequence connectors into account. Other than that, a search for a joint predecessor process step which does not explicitly enforce an exclusive branching is performed. The heuristics may yield some false positives (process steps which do not actually execute simultaneously at runtime), as well as some false negatives (process steps which are classified as purely sequential but actually execute simultaneously). However, the disadvantage of having few false positives/negatives is compensated for by the very efficient implementation of that algorithm.

By rearranging conflicting process steps (swapping neighboring process steps and pushing process steps in front of and behind a parallel block), the conflict is resolved. Different patterns apply for various scenarios where we roughly differentiate between simple conflict resolution cases (which merely push a conflicting process step in front of or behind a parallel block) and complex resolution cases where the process must be transformed into a simple scenario, taking the mutual dependencies between process steps into account.

Sequentializing resource contentions helps to drastically reduce the occurrence of resource contentions that arise from concurrent accesses to shared resources. In effect, fair progress inside process instances (among different branches) also benefits from avoiding recurrent rollback/retry cycles of process steps that fail due to resource conflicts. Similarly, process turnaround times may be reduced by fewer occasions where process steps need to wait for blocked resources.

Conversely to sequentializing process steps that are prone to resource contentions, process performance generally benefits from concurrency among mutually independent process steps. That is, process steps that do not interact with one another may be executed in parallel, thus unblocking the two process steps and better utilizing spare CPU resources.

In one example, two sequentially connected process steps can be parallelized by inserting an AND split gateway in front, placing the two previously sequential process steps on the gateway's two outbound branches, and synchronizing both branches back to a single branch using an AND join gateway. As both process steps may now run simultaneously (provided that no resource contentions exist in between these), the process' overall duration may be potentially shortened. That is, a sequence of process steps takes t₁+t₂ to complete, where t₁ and t₂ are the individual durations of those process steps. That time is shortened to max(t₁, t₂) such that the greatest savings are achieved if both process steps have similar durations. However, if one of the two process steps takes much more time to complete, the benefit of parallelism is lessened. Also, the overhead of the additional AND join and AND split gateways which perform the control flow operations to synchronize and fork the parallel branches, respectively, should be added.

Taking the aforementioned considerations into account, the goals of sequentializing process steps include achieving a good balancing among durations to run the process steps from all parallel branches, avoiding (accidentally introduced) resource contentions (such as conflicting accesses to the process' data context) from parallel branches, adjusting the AND split “fan-out” (i.e., the number of parallel branches that are forked) to the available computing resources (in particular, the number of spare operating system threads), and minimizing the number of newly inserted control artifacts (basically AND joins/AND splits).

A combined approach is used to adhere to the aforementioned principles, which is to make use of the notion of implicit and explicit resources and the interaction relationship to model dependencies between process steps and detect any resource contentions. When resource contentions are detected that inhibit two process steps from being executed in parallel, an attempt to swap the conflicting process step with another process step is made. In effect, the re-ordered process steps may be parallelized.

In detail, the algorithm may work by trying to aggressively parallelize mutually independent process steps by looking ahead downstream and finding suitable process steps. While doing so, the algorithm builds up a set S of newly created parallel branches Bᵢ where S={B₁, B₂, . . . , B_{N}}, and each branch is a single-entry, single-exit process fragment (in the simple-most case, a single process step). The algorithm starts at (1) the current branch's first process step (initially, the process' start event) and traverses the control flow of the process model downstream. At (2), for each (non-branching/non-merging) process step P_{C} that is encountered, a check is performed as to whether there is no branch Bᵢ having some other process step that interacts with P_{C}, or vice versa. A process step A interacts with another process step B if and only if B reads data from or updates an internal or external resource that A has previously updated. Restated, A's change of that resource may alter the behavior of B due to the jointly accessed resource.

At (2)(a), if Bᵢ exists, a check is performed as to whether there is a second branch Bⱼ (that is different from B) which has some process step that interacts with P_{C}, or vice versa. At (2)(a)(ii), if (2)(a) above holds (i.e., P_{C} interacts with process steps from at least two parallel branches), an attempt to swap P_{C} with some other downstream process step P_{D} (where “D” stands for “downstream”) is made, and the process starts over with P_{D} at step (2). If there is no P_{D} that can be swapped against P_{C}, an AND join gateway that synchronizes all branches from S is added, and P_{C} is placed behind that gateway, before allowing the process to proceed to the downstream successor process step of P_{C}. At (2)(a)(ii), however, if no Bⱼ exists (i.e., P_{C} interacts with process step(s) from exactly one branch [or vice versa]), P_{C} is placed onto Bᵢ and proceeds to the downstream successor process step of P_{C}. At (2)(b), if no Bᵢ exists (i.e., P_{C} does not interact with process steps from any of the parallel branches in S [and vice versa]), a new branch B_{N+1} is created and P_{C} is placed onto it. In this case, parallelism may be improved by adding another parallel branch and placing a process step Pc (“C” meaning “current”) in parallel to the other process steps, where the process step is sequential to the other process steps before the optimization. The operation then proceeds to the downstream successor process step of P_{C}.

At (3), if the current process step entails branching or merging of the control flow (e.g., through gateways or boundary events, which are attached to or associated with sub-processes), the parallel branches from S are synchronized by placing an AND split gateway in front of them and AND join gateway behind them. For branching process steps (i.e., where the control flow diverges into multiple branches), new separate (initially empty) sets Sᵢ for each outbound branch of the branching gateway are designated and the operations recursively starts over at step (2). For merging process steps, the algorithm waits until all inbound branches are completed in this manner, then designates a new empty set S′ for the outbound control flow of the merging gateway and starts over at step (2).

The benefit of parallelizing independent process steps lies in yielding much better turnaround times for a process instance. As a side effect, process throughput both benefits (e.g., on average, processes take less time to complete) and, to a small extent, also suffers from this optimization due to a better utilization of computing resources per process instances such that simultaneously running processes may get fewer of those resources. When processes are subjected to this optimization, they make better progress than other (purely sequential) processes where the optimization was not (or sometimes cannot) be applied. Due to the extra AND-split/AND-join pairs, a minor increase in the static footprint may be produced. Likewise, each parallel branch comes with some runtime overhead in terms of memory consumption (e.g., a control flow “token”). Neither the transaction load nor the likelihood of resource contentions is affected by this optimization.

The operations associated with the next logical optimization, transactional scope extension, have been previously described in detail. The benefits associated with this optimization include minimizing the number of transactions performed by a business process, which indirectly improves process performance and may reduce the likelihood of resource contentions. In some instances, the transactional scope extension optimization reduces the dynamic footprint. On the downside, combining multiple sequential process steps into a single transaction may have a negative impact on making fair progress among parallel process branches and other process instances. Because of the latter, process throughput may also be negatively impacted. However, the aforementioned improvements outweigh the potential disadvantages of this optimization strategy.

Both in terms of modeling effort and runtime cost, data flow operations typically outweigh control flow steering. This is due to the fact that business processes often integrate heterogeneous systems where costly data transformations need to be applied to normalize on a canonical representation of business data within the process. Thus, data flow-oriented optimizations are a natural domain of an optimizing BPM compiler.

The first data flow-oriented optimization is data mapping redundancy elimination. Identical operations are redundantly used in many places. For instance, when instantiating the process data context comprising multiple identically-typed data objects, one and the same initial value is often assigned to those data objects. Generating those values is a costly optimization that comprises (a) instantiating the type into some empty (uninitialized) value container and (b) mapping a default initial value to that value container.

If multiple data objects were initialized to the same value (e.g., as part of the start event's output mapping), the aforementioned steps would ideally be performed only once, assigning the generated value (or a copy thereof in case of mutable types) to all affected data objects. Data context initialization would frequently benefit from that optimization, as types tend to be re-used for multiple data objects (e.g., processes that hold their context data in multiple string-typed data objects which are initialized to an empty string). In other cases, data structures from a particular business domain (e.g., a sales order document, which is an example of a business document) are re-used for multiple data objects in the process' data context. The latter case is particularly costly, as those data structures often comprise many fields, scattered across different nesting levels. Instantiating the corresponding types into an uninitialized value container translates to traversing the type, creating an empty container for each nested type, and wiring up that container to its parent container. Similarly, mapping default values to that structure requires recursively traversing the container and assigning default values to the contained fields. Conversely, merely copying a data structure that was once created and initialized it in a way is often much more efficient and may be natively supported by the underlying data binding mechanism (e.g., SDO, JAXB, JSON, XML, etc.).

Apart from eliminating redundancies in initializing a process' data context, redundancies may also exist among (portions of) mappings. For instance, mapping some identical constants to different target structures may occur in a single complex mapping, multiple mappings within the same process step (e.g., in its input and output mapping), or even in mappings that map data in different process steps. Those redundancies often affect portions of a complex mapping, only, where two (complex) mappings may be different as a whole but share identical sub-mappings.

Technically, this optimization requires to build a directed acyclic graph (DAG) of all mappings that shall be subject to redundancy elimination (i.e., where a node in that DAG is a single expression used inside that mapping, pointing to other nodes that represent sub-expressions of this expression). That is, the “scope” of the optimization may be all mappings in an entire process, a sub-process, a series of sequential process steps, a single process step, or a single mapping. Inside that DAG, expressions that are re-used in that scope are identified by a graph isomorphism algorithm Any re-used expressions are eliminated and the mapping assignments or other expressions that were using them need to reference the identical expression instead.

In the data mapping redundancy elimination operation, the compiler's transformer stage considers mapping expressions having multiple referees by generating code that caches the resulting values at runtime. The lifetime of those caches depends on the aforementioned optimization scope. For each of the different scopes, that cache needs to exist for the “lifetime” of that scope, and can then be cleaned up. As the cache consumes runtime resources (e.g., main memory or physical disk space), the cache lifetime needs to be adjusted to the availability of these resources. In scarce memory situations, the runtime would need to fall back to re-calculating an expression that was evicted from the cache. The data mapping redundancy elimination optimization can improve both turnaround time and the static footprint by making the portions of the binary that represent the data mappings more compact, as redundancies are eliminated by a cache lookup.

The next example data flow-oriented optimization is premature correlation scope termination. Message correlation is one of the most useful patterns in business processes, providing the means to synchronize the state of a business process (e.g., its progress) in the environment. That is, processes may block their operations until a message from some external system is received. Message receipt is guarded by correlation conditions which further specify filter criteria on an incoming message and the process' data context.

Business processes need to adhere to some basic consistency constraints with respect to message correlation. This includes “exactly once” message receipt where a message that comes in while a correlation condition holds true must be initially queued for being delivered to the process when it reaches a receiving process step (such as intermediate message events in BPMN). Furthermore, some scenarios from the system's integration domain implement “collect patterns,” where a single process instance is responsible for receiving a fixed number of messages before the next process instance can be launched to receive the subsequent batch of messages.

Queuing messages for subsequent delivery is an expensive operation that consumes runtime resources and occurs in extra transactions. Other than that, processes that are subject to the “collect pattern” are specifically performance-critical in terms of process throughput. That is, a BPMS receiving messages with a high frequency will need to quickly dispatch those messages to a receiving process. In case of the aforementioned “collect pattern,” a message may either be delivered to a running process instance or launch a new process instance. Specifically, a message will only trigger a new process instance if the predecessor process instance cannot receive any more messages. By default, that only happens when the predecessor process terminates such that, in effect, the predecessor and successor processes do not overlap (in terms of their lifetime).

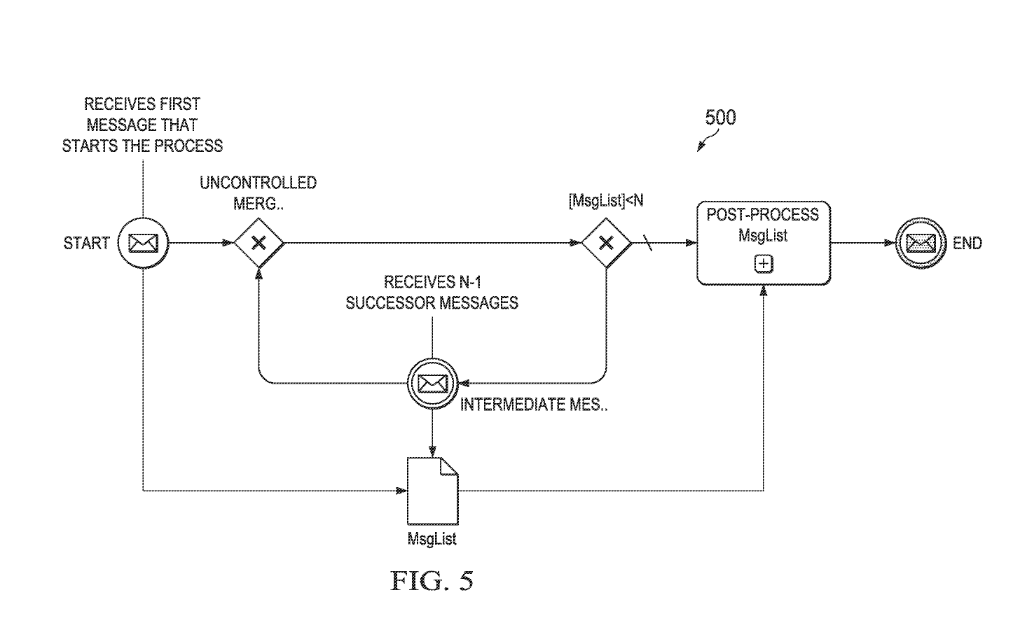

FIG. 5 illustrates an example process model 500 that include a simple collect pattern, where the process' start event collects the first out of N messages that are successively received by that process instance. A sequential loop pattern represented by the process fragment between the two gateways recurrently triggers an intermediate message event (receipt) process step until a corresponding “MsgList” data object holds N messages. Downstream, a sub-process providing a post-processing stage of that process is located where no further messages are being received by that process instance.

Processes implementing “collect patterns” are often split into two parts—a first part where the batch of messages is successively received and a second part where the received messages are post-processed (which may entail computing aggregates, calling services of other business applications, or even performing user interactions). While the second part may take a significant amount of time to complete, it does not actually receive any more messages. That is, messages coming in while the process' second part is still busy (1) need to be queued (which, as mentioned, is a costly operation) and (2) delay the launch of a successor process instance which was able to pick up those messages.

Technically, determining whether or not a message will be queued for some process instance is based upon two conditions: (1) the process was not yet completed, and (2) its correlation condition holds true. A process in its second stage is not complete. The correlation condition, however, can implicitly be tweaked or modified to stop matching new incoming messages. This optimization phase introduces the means to automatically alter the correlation condition as soon as a process instance is no longer running into a receipt step (e.g., an intermediate message event in BPMN). Generally, conditions which are statically fixed cannot be altered. However, altering the processes' data context (e.g., assigning values to data objects) in a way that the correlation condition, which may reference data objects from the data context, yields a “false” result (i.e., does not match a particular message).

Typically, correlation conditions are specified as part of the process model and cannot (directly) be altered at runtime. For instance, the BPMN standard names two alternatives for defining a correlation condition where one (“context-based correlation”) relies on a Boolean predicate atop the message payload and the process data context and the other (“key-based correlation”) introduces dedicated “CorrelationKey” entities that are compared against new incoming messages and their “CorrelationKeys” and that can be explicitly populated at runtime (by performing data mappings from process steps). Both alternatives are semantically equivalent, but are aimed at different use-cases. Key-based correlation is inspired by BPEL, targeting system integration scenarios whereas context-based correlation considers a correlation condition as a logical test that determines whether or not a message is received.

Without loss of generality, the optimization for “context-based correlation” only is illustrated. The idea of this optimization is threefold: (1) the process context is augmented with an additional Boolean data object named “matches” that is initialized to “true” and adds a (sub-) predicate “ . . . and matches=true” to the correlation condition; (2) a control flow analysis is performed to determine the point(s) of no return within a business process where a receipt step can no longer be reached (e.g., such as when a loop has been exited out of that contained that receipt step); and (3) where those points of no return are instrumented (if possible) with data mapping instructions that flip the “matches” data object from “true” to “false,” thus inhibiting the correlation condition from matching further messages. If some process step that marks a point of no return does not allow for adding data mapping instructions, a dedicated process step doing so downstream from the point of no return is introduced.

FIG. 6 illustrates a process model 600 that has transformed the collect pattern from example process model 500, highlighting the “point of no return” (which is on the right outbound branch of the |MsgList|<N XOR split gateway) where a dedicated Mapping Activity takes care of flipping the “matches” data object to “false.” The simple modification effectively ensures that messages which are received after that stage will no longer be queued for this process instance. Any message that has come in between the last time the process' receipt step was triggered and the point of no return will be de-queued, thus made available for a successor process instance.

This optimization's major impact is to ensure a good process throughput for high-load message collect scenarios that are often found in system-centric processes. In effect, multiple process instances may simultaneously make progress (i.e., one is still busy collecting messages while the others [predecessors] are performing their post-processing steps). Due to the additional data object, the augmented correlation condition, and the extra mappings to flip the “matches” data object, there is a slight (almost negligible) increase in the process' static and dynamic footprint, as well as its turnaround time. The transaction load benefits from fewer occasions when a message needs to be queued (instead of being delivered to a [successor] process instance right away), which provides a pronounced improvement.

The example physical optimizations that can be performed by the compiler 130 and its components are a one-step process termination and batched multiple instance activity parallelism, among other. The details of the one-step process termination are described in co-pending U.S. application Ser. No. 13/289,606 filed on Nov. 14, 2011 (“application Ser. No. 13/289,606”), hereby incorporated by reference in its entirety. In general, process instances have complex statuses that are maintained in status variables for control flow tokens, data objects, and others—typically adding up to a two-digit number of status variables per process instance. Any top-level process instance and sub-process has its own set of status variables. In some instances, even user tasks may maintain their own status variables.

When processes terminate, any associated status variable needs to be cleaned up. The former is essential to avoid memory leaks and to notify BPMS components that “track” those variables when the process had ended. For instance, certain BPM suites may have dedicated components for process management (which track process instances and tokens) and context management (which track data objects). Those components need to perform finalization actions such as to clean up any associated internal state or to write log entries (such as the final status of some data object).

BPMN provides for various artifacts that will or may end a process instance. That is, some artifacts such as terminating end events and error end events will unambiguously end the process instance. Other types of end events, such as message end events, escalation end events, and others, merely complete a single thread of control (i.e., a token), leaving other process threads unaffected. The process instance will only be terminated once the last token has vanished. The latter requirement poses a dilemma for code that is generated for non-terminating end events, as rules that are compiled for these entities do not take other process branches into account. Consequently, there are separate rules (1) for end events which (among other things) “delete” a single token, (2) for terminating a process instance if there are not any tokens left, and (3) for deleting any status variable once the associated process has terminated. That chain of events leads to a high number of transactions that are run in sequence once a process/sub-process/task instance is about to end.

One-step process termination provides an optimization phase that uses the first-order logics (FOL) foundations of event-condition-action (ECA) rules that are run in the BPM kernel. That is, rules for regular (non-terminating) end events are altered to support two cases when the end event deletes the last token or when there are other tokens left in this process instance. This optimization also retains rules for process termination (once the last token has vanished), cleaning up a status variable (once the process has terminated) to facilitate administrative actions from outside which may forcefully cancel a process or set a single token to completion. While those rules continue to contribute to the process' static footprint, the turnaround time benefits from this change that reduces the number of follow-up rules which fire upon the last token's removal. Other than that, the transaction load is reduced and the resource contention likelihood is greatly reduced. By occupying fewer (concurrent) transactions for process termination, fairness to other process instances is also slightly improved. On the downside, there is a slight increase in the static footprint of the process (only if separate cleanup rules are kept). Further description and techniques for applying this optimization are described in the co-pending application Ser. No. 13/289,606.

Business processes are driven by the data upon which they operate. Various workflow patterns support dynamically manipulating a process' control flow by evaluating the data that is stored in the process context. Among these, the “Dynamic Parallel Looping w/o a priori Runtime Knowledge” pattern is particularly useful when a flexible number of parallel actions are to be taken on “line items” from a data collection (i.e., a list-valued data object form the processes' data context). For instance, a process might control the assembly of some product where components as initially listed on a Bill of Materials need to be picked from an inventory. If the physical infrastructure allows, selecting the different components may occur in parallel. When the processes operate on different Bills of Materials, flexible numbers and types of components may need to be selected, such that all conceivable combinations of components cannot be adequately modeled in a process model. BPMN's “Multiple Instance Activities” (MI activities) provide a single-process step (which may also be a placeholder for an entire sub-process) operating on a collection of line items (in this example, the Bill of Material) in parallel. MI activities do not generally anticipate or estimate the number of parallel process steps that need to be spawned to process all line items.

In some BPM systems, MI activities can be implemented by initially breaking down the collection of line items into as many sets of “seed objects” (such as individual line items, tokens, and additional status variables) as there are line items in the collection. That is, all of the required parallel process steps are spawned simultaneously and irrespective of the available computing resources. Doing so does not only significantly increase the dynamic footprint (for holding the seed objects of all parallel process steps), but also negatively impacts the likelihood for resource contentions (the initial transaction which generates all seed objects lasts very long and is, thus, prone to resource contentions). In addition, the available runtime resources (number of operating system (OS) threads to process the different line items) can easily be depleted for large resources which is a resource contention (in terms of CPU cycles, OS resources). In effect, this may cause an unintentional block of concurrent processes receiving their fair shares of common resources.

The idea and purpose of this optimization phase is to introduce a sliding window-style, batched approach to processing MI activities. That is, the compiler rules are altered in a way that initially only N line items are processed, where N is the minimum out of the data collection's size and an upper threshold to the OS threads that are occupied by this process instance at runtime. For instance, in one BPM solution, the default setting for OS threads that are allocated to all process instances in a BPMS system is 10 (i.e., N should be less than that). Only when a line item is completed, a pending line item from the collection is scheduled for processing. As a result, no more than N threads should be busy processing line items at a time. Example code (or ECA rules generated by the transformer stage before being transformed into the actual process binaries or Trigger Networks by the compiler backend) may include the following:

```
  Rule startMultipleInstanceActivity {
        if exists Process p (not p.suspended and
          exists Token t (t.owner=p and t.state=<before
MI activity>)
        )
    enable {
      // set token state to in progress
      t.state=<processing MI activity>;
      // populate collection
      . . .
      // count and record the number of line items
      t.pending=<size of collection>;
      // initialize the number of current threads to 0
      t.threads=0;
    }
  }
```

A first rule “startMultipleInstanceActivity” is triggered when the process has reached the MI activity (t.state=<before MI activity>). The rule sets the token to a special state which marks the ongoing execution of the MI activity. Furthermore, the rule populates the collection of line items, which may entail dynamically computing a data expression, and calculates the number of “pending” line items which are tracked in a token attribute “pending.” The rule also monitors the currently processed line items in an attribute “threads” that is initialized to zero.

A second example rule launchCycle is provided below:

```
  Rule launchCycle {
    if exists Process p (not p.suspended and
          exists Token t (t.owner=p and
t.state=<processing MI activity> and t.pending>0 and
t.threads<N)
        )
    enable {
      // create new seed token
      t′ =new Token(t, <before loop cycle>);
      // extract line item from collection and assign it
to t′
      new LineItem(t′ ,collection [t.pending] );
      // increase #threads
      t.threads++;
      // decrease #pending line items
      t.pending−−;
    }
  }
```

The rule “launchCycle” spawns a new loop cycle that processes the next line items from the collection. That rule is triggered whenever there are any (pending) line items left and if the current number of concurrent threads is below N. The rule creates a “seed token” t′ (i.e., a token that is solely responsible for triggering the execution of a single line item), extracts the corresponding line item from the collection, increases the number of concurrent threads, and decreases the number of pending line items.

Another example rule, completeCycle, is provided below:

```
    Rule completeCycle {
      if exists Process p (not p.suspended and
            exists Token t (t.owner=p and
t.state=<processing MI activity> and exists Token t′
  (t′ .owner=t and t′ .state=<after loop cycle>)
            )
          )
      enable {
        // delete seed token
        delete t′ ;
        // decrease #threads
        t.threads−−;
      }
    }
```

The successor rule “completeCycle” waits for a loop cycle to finish its processing to clean up the seed token t′ and decrease the number of threads, again.

Finally, the rule “endMultipleInstanceActivity” waits until there are neither any pending line items nor busy threads before it continues the process.

```
  Rule endMultipleInstanceActivity {
    if exists Process p (not p.suspended and
        exists Token t (t.owner=p and
t.state=<processing MI activity> and t.threads=0 and
t.pending=0)
        )
    enable {
      // set token state to after the MI activity
      t.state=<after MI activity>;
    }
  }
```

The benefits of this optimization lie in the simplicity of choosing slightly changed rules that rely on two newly introduced counters for the number of currently running threads and the number of pending line items. The optimization successfully brings down the number of sets of seed objects to N and thus drastically reduces the process' dynamic footprint in terms of memory consumption and concurrent OS threads, among others. Also, there are separate rules for creating the seed objects for a single line item such that the transaction length is drastically reduced, which helps to avoid resource contentions. As a result, improvements are seen on the performance numbers which benefit from running into fewer resource contentions (thus, fewer lock acquisition delays or even rollback-retry cycles). On the downside, the number of transactions grows. However, these transactions are not executed simultaneously, but equally benefit from the sliding window-like behavior where new transactions are only progressively executed when the previous line item was completely processed. As already explained, fair progress among different process instances is improved due to a more moderate allocation of computing resources.

Adaptive compilation denotes a concept where the choice and order of optimization phases that are applied depend on (1) the business process at hand and (2) the specific optimization goals to be pursued for the target BPMS infrastructure. Regular compiler tool chains offer fixed optimization pipelines (such as −Os, −O1, −O2, and −O3 in the “GNU Compiler Collection”) that a programmer needs to deliberately choose from among when building a program binary. Research has also created adaptive approaches that employ optimization heuristics to accomplish even better optimization by building flexible optimization pipelines that result in even better results.

Apart from the latter approach, which is not yet in wide-spread use, manually choosing among a plethora of compiler switches increases TCO and may be ill-suited for a typical BPMS user lacking the necessary IT expertise to make a meaningful choice. Therefore, certain characteristics of the target infrastructure (and its associated optimization goals) can be extracted from the IT landscape and the BPMS itself. The following information can be exploited to identify a good, or optimal, optimization pipeline:
Target landscape (development system, production system);
Deployment option (local, on-premise, cloud-based installations);
Prevalent usage type (human-driven processes, system-centric processes);
Current (average) CPU load on BPMS nodes; and
Current (average) CPU load on database node(s), among others.

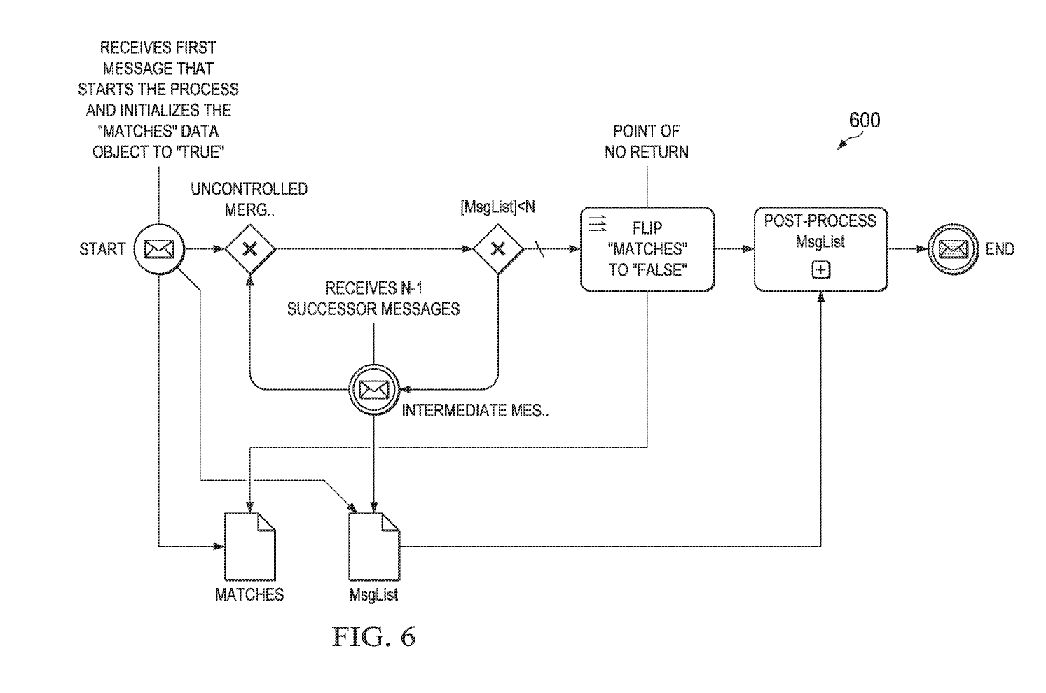

Taken together, an infrastructure profile with accompanying optimization goals can be derived, which can be broken down into concrete optimization pipelines as illustrated in FIG. 7.

The table 700 of FIG. 7 provides an indication on what optimization goals to focus on when certain characteristics of the IT infrastructure are present. The cells list the variants for the infrastructure options in the first row that may benefit from pursuing the corresponding optimization goal on the left-hand side. A blank cell denotes no specific emphasis on a particular optimization goal to support a particular variant.

For instance, a productive cloud installation for running human-centric processes, where the BPMS CPU load is at 30% and the database CPU load is at 70%, may suggest an optimization be applied that reduces the static footprint (due to the limitations in main memory on a cloud infrastructure that is shared between many applications and users), for a reduced transaction load (due to the high CPU load on the database server), and for a smaller dynamic footprint (to bring down the amount of data that needs to be written to the database), among other optimizations.

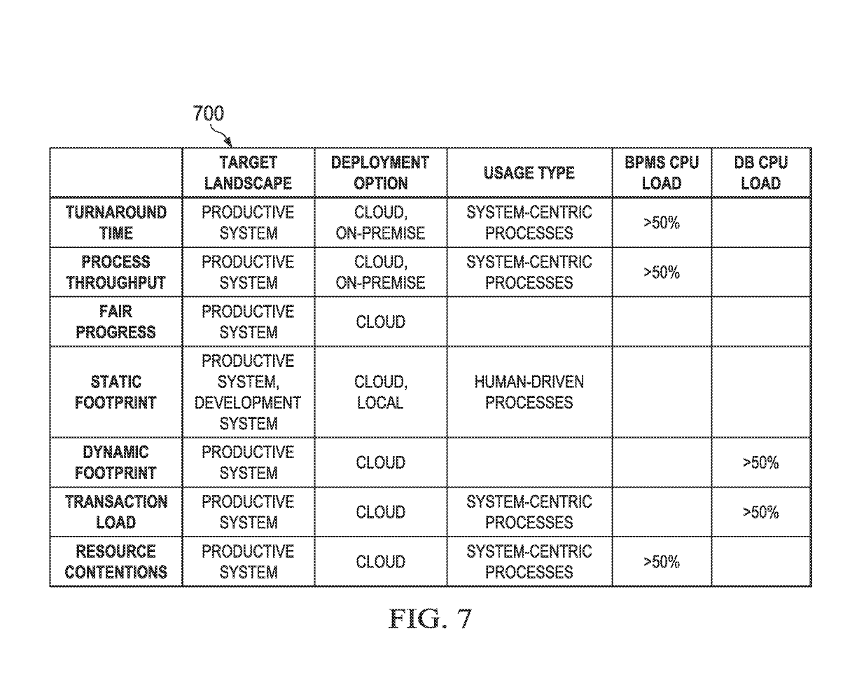

With respect to the optimization phases should be chosen and in which order they are best performed, the proposed classification into logical optimizations and physical optimizations with an associated staging in the compiler pipeline (as illustrated in FIG. 4) provides indications on how to schedule or order the optimizations. Similarly, the impact assessment of the individual optimization algorithms may be consulted and compared to provide a reasonable order. An example of the suggested sequence of optimizations is provided in table 800 of FIG. 8.

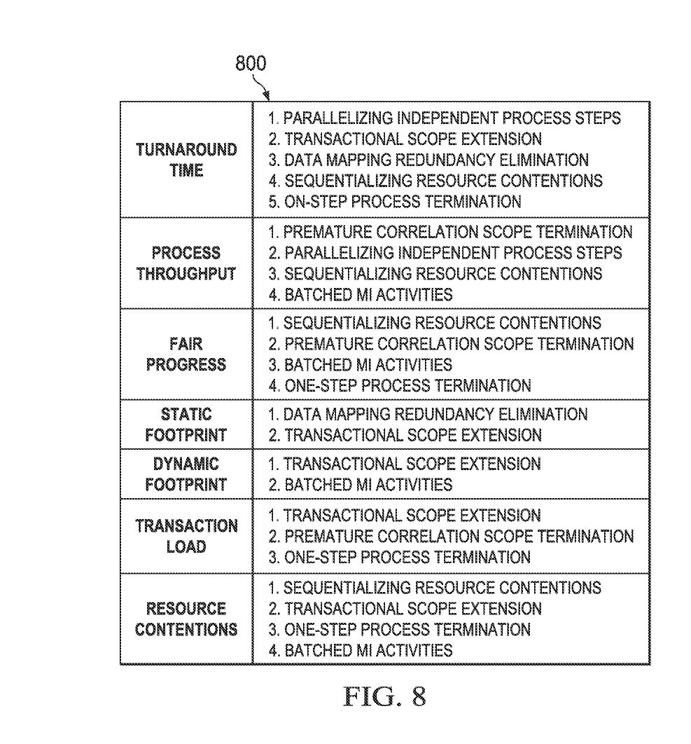

FIG. 9 is a flowchart of an example method 900 for performing an adaptive compilation to a process model. For clarity of presentation, the description that follows generally describes method 900 in the context of environment 100 illustrated in FIG. 1 and the compiler 130 illustrated in FIG. 4. However, it will be understood that method 900 may be performed, for example, by any other suitable system, environment, or combination of systems and environments, as appropriate.

At 905, a set of IT landscape characteristics is identified. Those IT landscape characteristics may contain information including, but not limited to, the target system landscape (i.e., whether the process will be executed on a development system, a quality assurance system, production system etc.), the particular deployment of the process (e.g., local, on-premise, cloud-based installations), a prevalent usage type associated with the process (e.g., human-driven processes, system-centric processes), and one or more identified or derived KPIs associated with the system (e.g., current average CPU load on BPMS nodes and/or current average CPU load on database node(s)), among others. Some or all of the IT landscape characteristics can be retrieved, for example, from a system monitoring tool, as well as based on IT system information defining characteristics, information, and planned usages of the process. In other instances, the compiler may be associated with an IT-related application, where the IT-related application can request additional information from users requesting the compiling of the process model for additional information as to the use, purposes, and proposed IT landscape where the compiled process model (or process binary) will be used or associated with.

At 910, at least one optimization goal is identified. In some instances, the optimization goals may be defined by an administrator associated with the compiler, allowing the compiler to identify a particular goal or set of goals to be met or used to determine the appropriate optimizations to apply. The optimization goals may be a static set of goals associated with a particular IT system or set of systems, while, in other instances, the optimization goals may be derived from or associated with the identified IT landscape. For example, the table 700 of FIG. 7 identifies potential optimization goals based on the identified IT landscape. For example, if the target landscape is a productive system, the deployment is cloud-based or local, and the prevalent usage type is a human-driven process, a matching optimization goal would be reducing the static footprint of the corresponding process binary. Where the identified IT landscape meets the criteria for multiple goals, the goals themselves can be prioritized based on the best fit to a particular optimization goal, as well as to an order that makes sense for the optimization stages (e.g., logical optimizations prior to physical optimizations). At 915, a proposed (and, in some cases, ordered) set of optimizations are identified based on the identified IT characteristics and the optimization goals. Table 800 of FIG. 8 provides a set of example ordered optimizations depending on the particular identified optimization goals.

At 920, the process model is input to the compiler, where the identified set of optimizations is applied to the process model and its intermediate representations (as described with regard to FIG. 4) to generate an optimized and compiled process model, now an optimized process binary. In some instances, the sequence of optimizations from 915 can form the optimization pipelines for the logical and physical optimizers. At 925, the optimized process binary is deployed to its corresponding target system, where the process binary can be put into operation.

The preceding figures and accompanying description illustrate example processes and computer implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously, concurrently, and/or in different orders than as shown. Moreover, environment 100 may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method performed by one or more processors for optimizing process models, the method comprising:
identifying a set of information technology (IT) characteristics associated with execution of a process model;
identifying at least one optimization goal associated with the process model;
identifying a set of at least one optimization technique based on the identified set of IT characteristics and identified optimization goals associated with the process model; and
compiling the process model, where compiling the process model includes applying the set of the at least one optimization technique during compiling operations.

2. The method of claim 1, wherein the set of IT characteristics associated with the execution of the process model includes:
information defining a landscape type of a target system in which the process model is to be deployed;
at least one probable deployment option of the process model;
a probable usage type associated with the process model; and
at least one identified performance factor associated with the target system.

3. The method of claim 2, wherein the type of the target system landscape includes one of the following: a development system, a quality assurance system, and a production system.

4. The method of claim 2, wherein the at least one probable deployment option of the process model includes at least one of a local, an on-premise, or a cloud-based deployment.

5. The method of claim 2, wherein the probable usage type associated with the process model includes at least one of a human-driven process interaction or a system-centric process interaction.

6. The method of claim 2, wherein the at least one identified performance factor associated with the target system includes at least one of the following;
an average CPU load on business process modeling suite nodes associated with the target system; and
an average CPU load on database nodes associated with the target system.

7. The method of claim 1, wherein identifying the at least one optimization goal associated with the process model includes comparing at least a portion of the set of identified IT characteristics to a predefined set of optimization goals, where particular optimization goals correspond to particular IT characteristics.

8. The method of claim 1, wherein the optimization goals include at least one of the following:
improved turnaround time;
improved process throughput;
assurance of fair progress and execution among concurrent processes;
improved size and complexity of a process binary generated by compiling the process model;
improved resource consumption of the compiled process instance at runtime;
improved transaction load associated with the executing compiled process model; and
a decreased frequency of resource contentions.

9. The method of claim 1, wherein identifying the set of at least one optimization technique based on the identified set of IT characteristics and identified optimization goals associated with the process model includes determining an order in which to apply the set of the at least one optimization technique.

10. The method of claim 1, wherein compiling the process model is performed by an adaptive compiler, the adaptive compiler comprising a set of logically distinct modules including a front-end process model analyzer, a logical optimizer, a compiler code generation phase transformer, a physical optimizer, and a compiler back-end.

11. A computer program product encoded on a non-transitory, tangible storage medium, the product comprising computer readable instructions for causing one or more processors to perform operations comprising:
identifying a set of information technology (IT) characteristics associated with execution of a process model;
identifying at least one optimization goal associated with the process model;
identifying a set of at least one optimization technique based on the identified set of IT characteristics and identified optimization goals associated with the process model; and
compiling the process model, where compiling the process model includes applying the set of the at least one optimization technique during compiling operations.

12. The computer program product of claim 11, wherein the set of IT characteristics associated with the execution of the process model includes:
information defining a landscape type of a target system in which the process model is to be deployed;
at least one probable deployment option of the process model;
a probable usage type associated with the process model; and
at least one identified performance factor associated with the target system.

13. The computer program product of claim 12, wherein the type of the target system landscape includes one of the following: a development system, a quality assurance system, and a production system.

14. The computer program product of claim 12, wherein the at least one probable deployment option of the process model includes at least one of a local, an on-premise, or a cloud-based deployment.

15. The computer program product of claim 12, wherein the probable usage type associated with the process model includes at least one of a human-driven process interaction or a system-centric process interaction.

16. The computer program product of claim 12, wherein the at least one identified performance factor associated with the target system includes at least one of the following;
an average CPU load on business process modeling suite nodes associated with the target system; and
an average CPU load on database nodes associated with the target system.

17. The computer program product of claim 11, wherein identifying the at least one optimization goal associated with the process model includes comparing at least a portion of the set of identified IT characteristics to a predefined set of optimization goals, where particular optimization goals correspond to particular IT characteristics.

18. The computer program product of claim 11, wherein the optimization goals include at least one of the following:
improved turnaround time;
improved process throughput;
assurance of fair progress and execution among concurrent processes;
improved size and complexity of a process binary generated by compiling the process model;
improved resource consumption of the compiled process instance at runtime;
improved transaction load associated with the executing compiled process model; and
a decreased frequency of resource contentions.

19. The computer program product of claim 11, wherein identifying the set of at least one optimization technique based on the identified set of IT characteristics and identified optimization goals associated with the process model includes determining an order in which to apply the set of the at least one optimization technique.

20. The computer program product of claim 11, wherein compiling the process model is performed by an adaptive compiler, the adaptive compiler comprising a set of logically distinct modules including a front-end process model analyzer, a logical optimizer, a compiler code generation phase transformer, a physical optimizer, and a compiler back-end.

21. A system, comprising:
one or more computers; and
a computer-readable medium coupled to the one or more computers having instructions stored thereon which, when executed by the one or more computers, cause the one or more computers to perform operations comprising:
identifying a set of information technology (IT) characteristics associated with execution of a process model;
identifying at least one optimization goal associated with the process model;
identifying a set of at least one optimization technique based on the identified set of IT characteristics and identified optimization goals associated with the process model; and
compiling the process model, where compiling the process model includes applying the set of the at least one optimization technique during compiling operations.
